(19) United States
(12) Patent Application Publication
(10) Pub. No.: US 2013/0279918 A1
(43) Pub. Date: Oct. 24, 2013

(54) POWER SAVING CONTROL METHOD AND NODE DEVICE IN OPTICAL COMMUNICATION NETWORK

(71) Applicants: Kenji Mizutani, Tokyo (JP); Masahiro Sakauchi, Tokyo (JP)

(72) Inventors: Kenji Mizutani, Tokyo (JP); Masahiro Sakauchi, Tokyo (JP)

(21) Appl. No.: 13/991,970

(22) PCT Filed: Dec. 5, 2011
(86) PCT No.: PCT/JP2011/006790

§ 371 Date: Jul. 1, 2013

(30) Foreign Application Priority Data
Dec. 6, 2010 (JP) 2010-271150

(51) Int. Cl. H04B 10/27

(52) U.S. Cl. CPC H04B 10/27
USPC 398/135

(57) ABSTRACT

A node device and a power saving method in an optical communication network system that can achieve both of a reduction in startup period and a reduction in power consumption. A node device (110) includes: a plurality of optical transceivers (111) on which a plurality of standby modes can be selectively set, the standby modes including a first standby mode in which the startup period is shorter than an allowable interruption period in the optical communication system and a first amount of power is consumed during standby, and a second standby mode in which the startup period is longer than the allowable interruption period and a second amount of power that is smaller than the first amount of power is consumed during standby; and a power consumption control section (112) which, based on usage states of the plurality of optical transceivers and a predetermined number of optical transceivers that should stand by in the first standby mode, dynamically allocates the plurality of standby modes to the plurality of optical transceivers so that a total amount of power consumption will be smaller.

### TECHNICAL FIELD

The present invention relates to techniques for power saving in an optical communication network.

### BACKGROUND ART

It is anticipated that network traffic capacities will rapidly increase, not only because of increasing network population in recent years but also because there are demands for delivery of high-definition moving images and requests for two-way real-time video services as typified by video telephone. With this increasing traffic, it is anticipated that power consumption of optical communication networks will also sharply increase, as described in NPL 1.

To radically achieve a reduction in power consumption even at peak hours of such network traffic, studies on optical path networks as shown in NPL 2 have been conducted. In optical path networks, since a route linking the start point and end point is set and secured beforehand, it is possible to omit electrical-to-optical/optical-to-electrical (OE/EO) conversion using an optical transceiver and routing calculation at intermediate nodes along the route. This is effective in particular when large-volume data such as a future high-definition moving image file is transmitted in a batch, and has a superior energy-saving effect to a future increase in traffic capacity.

On the other hand, in optical networks, applications requiring high reliability such as those for electronic commerce are used under the current situations, as described in NPL 3. Therefore, to realize such high reliability, networks without service interruptions are required. When a failure occurs, a period of service interruption needs to be minimized, for example, kept within a 50-msec bound as a target.

Moreover, for a method for achieving a reduction in power consumption, PTL 1 discloses a technology of controlling a startup period and power consumption, using a plurality of standby modes including a standby state, an awake state, and a sleep state.

[PTL 1] Japanese Patent Application Unexamined Publication No. 2006-211370

[NPL 1] ECOC2009, Paper 5.5.3 (ECOC 2009, 20-24 Sep., 2009, Vienna, Austria)

[NPL 2] “Network Architecture for Optical Path Transport Networks,” IEEE Transaction on Communications, Vol 45, Issue 8, 1997, p 968-977

[NPL 3] “GMPLS Based Fault Recovery and Extra LSP Service utilizing protection bandwidth,” TECHNICAL REPORT OF IEICE Vol. 103, No. 505, Dec. 11, 2003 issue (http://www.pilab.jp/activity/PN2003_{—}32.pdf)

### SUMMARY

### Technical Problem

However, an optical transceiver for long-distance transmission used at a node of an optical network takes time to start up because it is equipped with a sophisticated device using dense wavelength division multiplexing (DWDM). Therefore, even unused optical transceivers need to be always turned on, imposing limits on the effect of a reduction in power consumption. Specifically, at a transmission optical device for DWDM, in order to restrict fluctuations in its oscillation frequency within a ±2.5 GHz range, sophisticated analog control of temperature needs to be performed for several orders of seconds, and therefore its startup is slow, taking a period of 60 seconds. Generally, at nodes, such a delay is not permitted because a very large number of signals are processed in a short time. Accordingly, it has been necessary that an optical transceiver at a node be always turned on so that it does not take time to start up. For an example of the specification of a transmission optical device for DWDM, please refer to (http://www.jdsu.com/product-literature/52055206itla_ds_cms_ae.pdf).

Moreover, in optical path networks, there have been limits to the number of control parameters that can be controlled in an entire network. For example, at a network control section, which sets an optical path in a short time and instructs nodes accordingly, as control parameters to deal with increase, not only information to exchange and update but a time period required for path setting also increase. Therefore, it also has been necessary to achieve a reduction in power consumption without increasing control parameters in an entire network.

The present invention aims to provide a technique that solves the above-described problems, and an object thereof is to provide a node device and a power saving control method in an optical communication network system that can achieve both of a reduction in startup period and a reduction in power consumption.

### Solution to Problem

To accomplish the above-described object, a node device according to the present invention is a node device in an optical communication network system, characterized by comprising: a plurality of optical transceiver means on which a plurality of standby modes can be selectively set, wherein the standby modes include a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby; and a power consumption control means which, based on usage states of the plurality of optical transceiver means and a predetermined number of optical transceivers that should stand by in the first standby mode, dynamically allocates the plurality of standby modes to the plurality of optical transceiver means so that a total amount of power consumption of the node device will be smaller.

To accomplish the above-described object, a power saving control method for a node device according to the present invention is a power saving control method for a node device in an optical communication network system, the node device including a plurality of optical transceiver means on which a plurality of standby modes can be selectively set, the method characterized by comprising: making available a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby; and based on usage states of the plurality of optical transceiver means and a predetermined number of optical transceiver means that should stand by in the first standby mode, dynamically allocating the plurality of standby modes to the plurality of optical transceiver means so that a total amount of power consumption of the node device will be smaller.

To accomplish the above-described object, an optical communication network system according to the present invention is an optical communication network system in which a plurality of node devices are connected through a plurality of optical fiber lines, wherein each of the node devices includes a plurality of optical transceiver means on which a plurality of standby modes can be selectively set, the standby modes including a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby, the system characterized by comprising: a network control means which sets a predetermined number of optical transceiver means that should stand by in the first standby mode for each of the node devices and controls communication performed by the node devices; and a power consumption control means which, based on usage states of the plurality of optical transceiver means and the predetermined number of optical transceiver means that should stand by in the first standby mode, dynamically allocates the plurality of standby modes to the plurality of optical transceiver means so that a total amount of power consumption of a relevant node device will be smaller.

To accomplish the above-described object, a method according to the present invention is a power saving method in an optical communication network system in which a plurality of node devices are connected through a plurality of optical fiber lines, wherein each of the node devices includes a plurality of optical transceiver means on which a plurality of standby modes can be selectively set, the standby modes including a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby, the method characterized by comprising: a network control step for setting a predetermined number of optical transceiver means that should stand by in the first standby mode for each of the node devices and controlling communication performed by the node devices; and a power consumption control step for, based on usage states of the plurality of optical transceiver means and the predetermined number of optical transceiver means that should stand by in the first standby mode, dynamically allocating the plurality of standby modes to the plurality of optical transceiver means so that a total amount of power consumption of a relevant node device will be smaller.

### Advantageous Effects of Invention

According to the present invention, at a node device in an optical communication network system, it is possible to start up an optical transceiver at high speed while achieving a reduction in power consumption during standby.

### BRIEF DESCRIPTION OF DRAWINGS

[FIG. 1]

FIG. 1 is a block diagram showing a structure of an optical communication network system according to a first exemplary embodiment of the present invention.

[FIG. 2A]

FIG. 2A is a schematic diagram of an optical path network that is an optical communication network system according to a second exemplary embodiment of the present invention.

[FIG. 2B]

FIG. 2B is a block diagram showing configurations of the optical communication network system and a node device according to the second exemplary embodiment of the present invention.

[FIG. 3]

FIG. 3 is a diagram showing a structure of an operation mode DB on an optical transceiver according to the second exemplary embodiment of the present invention.

[FIG. 4]

FIG. 4 is a diagram showing respective structures of a table of optical transceivers' usage states, total amounts of power consumption, and mode change data according the second exemplary embodiment of the present invention.

[FIG. 5]

FIG. 5 is a sequence diagram showing an operational procedure at the time of setting up an optical path, at the optical communication network system and the node device according to the second exemplary embodiment of the present invention.

[FIG. 6]

FIG. 6 is a sequence diagram showing an operational procedure at the time of setting down an optical path, at the optical communication network system and the node device according to the second exemplary embodiment of the present invention.

[FIG. 7]

FIG. 7 is a block diagram showing a hardware configuration of the node device according to the second exemplary embodiment of the present invention.

[FIG. 8]

FIG. 8 is a flowchart showing an optical path control procedure of the node device according to the second embodiment of the present invention. [FIG. 9]

FIG. 9 is a flowchart showing a mode reallocation processing procedure of the node device according to the second exemplary embodiment of the present invention.

[FIG. 10]

FIG. 10 is a diagram showing a relationship between the total number of set paths and the number of optical transceivers then preferentially standing by in a high-speed startup mode, according to a third exemplary embodiment of the present invention.

[FIG. 11]

FIG. 11 is a diagram showing a relationship between a change in the total number of set paths per unit time and the number of optical transceivers then preferentially standing by in the high-speed startup mode in each direction, according to a fourth exemplary embodiment of the present invention.

[FIG. 12]

FIG. 12 is a block diagram showing configurations of an optical communication network system and a node device according to a fifth exemplary embodiment of the present invention.

[FIG. 13]

FIG. 13 is a diagram showing a structure of an operation mode DB on an optical transceiver according to the fifth exemplary embodiment of the present invention.

[FIG. 14]

FIG. 14 is a diagram showing respective structures of a table of optical transceivers' usage states, total amounts of power consumption, and mode change data according the fifth exemplary embodiment of the present invention.

[FIG. 15]

FIG. 15 is a sequence diagram showing an operational procedure at the time of setting up an optical path, at the optical communication network system and the node device according to the fifth exemplary embodiment of the present invention.

[FIG. 16]

FIG. 16 is a sequence diagram showing an operation procedure at the time of setting down an optical path, at the optical communication network system and the node device according to the fifth exemplary embodiment of the present invention.

[FIG. 17]

FIG. 17 is a diagram showing an example of combinations of power-saving standby modes according to the fifth exemplary embodiment of the present invention.

[FIG. 18]

FIG. 18 is a block diagram showing a hardware configuration of the node device according to the fifth exemplary embodiment of the present invention.

[FIG. 19]

FIG. 19 is a flowchart showing an optical path control procedure of the node device according to the fifth exemplary embodiment of the present invention.

[FIG. 20A]

FIG. 20A is a flowchart showing a mode reallocation processing procedure of the node device according to the fifth exemplary embodiment of the present invention.

[FIG. 20B]

FIG. 20B is a flowchart showing the mode reallocation processing procedure of the node device according to the fifth exemplary embodiment of the present invention.

[FIG. 21]

FIG. 21 is a block diagram showing configurations of an optical communication network system and a node device according to a sixth exemplary embodiment of the present invention.

[FIG. 22]

FIG. 22 is a block diagram showing a hardware configuration of a network control device according to the sixth exemplary embodiment of the present invention.

[FIG. 23]

FIG. 23 is a flowchart showing an optical path control procedure of the network control device according to the sixth exemplary embodiment of the present invention.

### DETAILED DESCRIPTION OF PREFERRED EMBODIMENTS

Hereinafter, exemplary embodiments of the present invention will be illustratively described in detail, with reference to drawings. However, components described in the following exemplary embodiments are only illustrative and are not intended to limit the technical scope of the present invention.

### 1. First Exemplary Embodiment

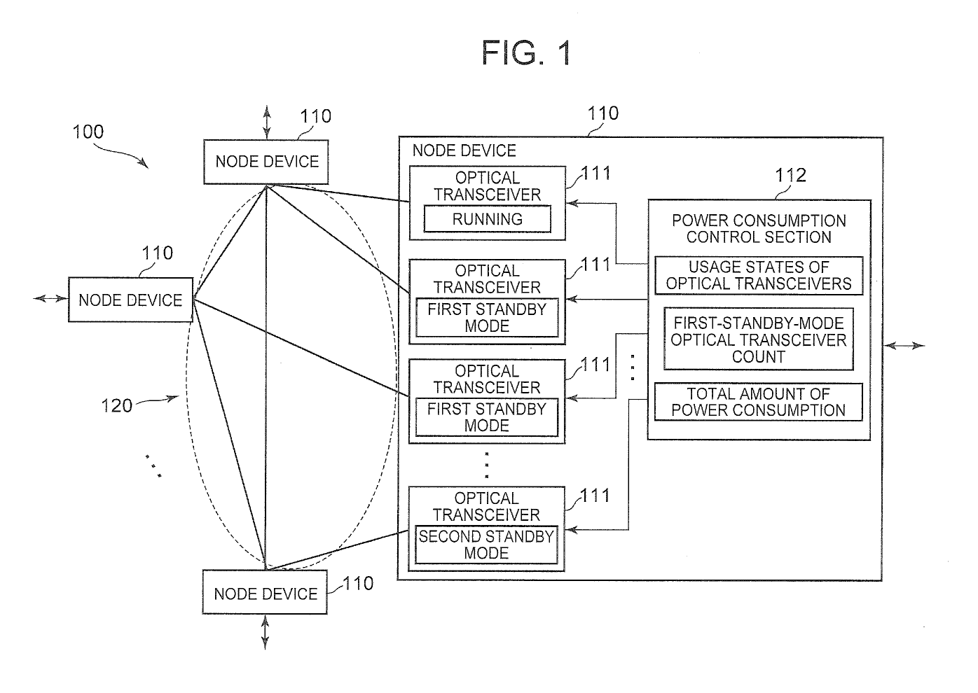

Using FIG. 1, a description will be given of a node device 110 in an optical communication network system 100 according to a first exemplary embodiment of the present invention.

Referring FIG. 1, the optical communication network system 100 is comprised of a plurality of node devices 110 being connected through an optical transmission network 120 of optical fiber or the like. The node device 110 includes a plurality of optical transceivers 111 and a power consumption control section 112. Each of the plurality of optical transceivers 111 has multiple levels of standby mode. The multiple levels of standby mode include a first standby mode in which a period of startup from a standby state of the optical transceiver 111 is shorter than an allowable period of interruption of a communication service in the optical communication system 100 and the optical transceiver 111 consumes a first amount of power, and a second standby mode in which the period of startup from the standby state of the optical transceiver 111 is longer than the allowance interruption period and the optical transceiver 111 consumes a second amount of power that is smaller than the first amount of power. The power consumption control section 112 controls the standby modes of unused optical transceivers 111, based upon the usage states of the plurality of optical transceivers 111 and upon the number of optical transceivers in the first standby mode that should be maintained by the node device 110, so that the total amount of power consumption of the node device 110 will be smaller.

According to the present exemplary embodiment, at a node device in an optical communication network system, a dynamic power-saving mechanism can be provided which allows high-speed startup of optical transceivers while achieving a reduction in power consumption during standby.

### 2. Second Exemplary Embodiment

Next, a second exemplary embodiment according to the present invention will be described in detail with reference to drawings. In a system according to the second exemplary embodiment, each node device in a network is configured to control a reduction in power consumption during standby and high-speed startup at the own device. According to the present exemplary embodiment, among a plurality of optical transceivers, a necessary number of them for recovery from a failure are set in a state capable of high-speed startup, and the others are set in a minimum power usage state, whereby the power saving due to a reduction in power consumption of node devices can be realized. Moreover, a control section within the node device performs power consumption reduction control of the optical transceivers, whereby power saving can be realized without imposing an excessive load on a network control device managing the entire network.

### 2.1) Optical Communication System

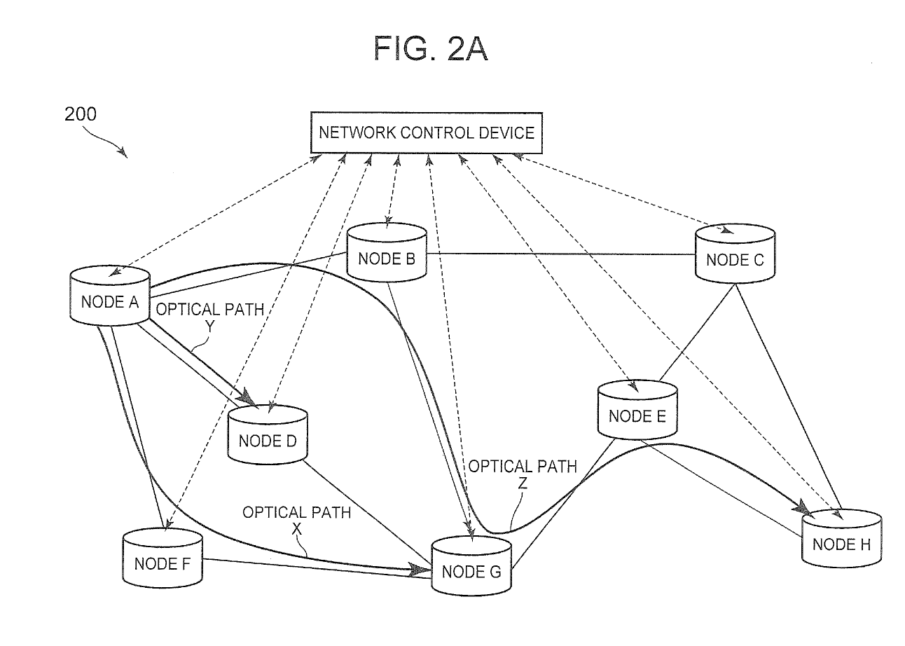

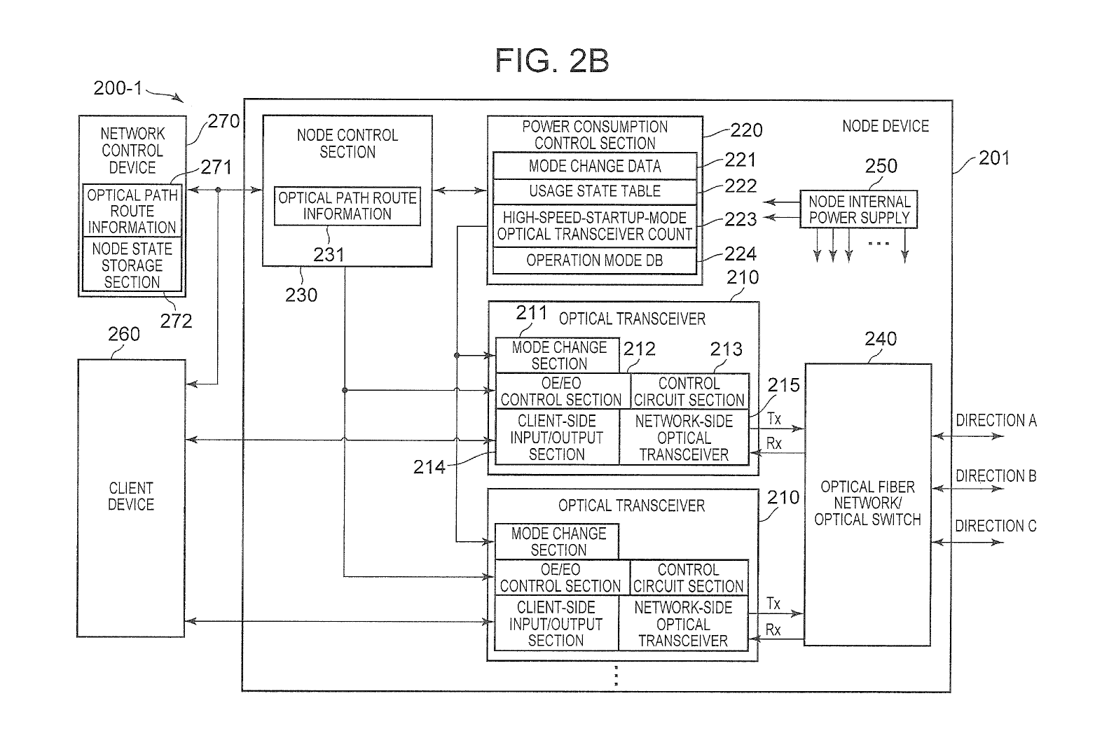

FIG. 2A is a schematic diagram showing an example of an optical path network system 200 that is a common optical communication network system in the present exemplary embodiment.

The optical path network system 200 in FIG. 2A includes a network control device controlling an entire network and nodes A to H that are node devices to provide optical path routes and also control transmission and reception of data to/from client devices. Control of optical paths, e.g., optical paths X to Z, in the optical path network system 200 is realized through coordination between the network control device and the node devices. Note that this control of the optical paths may be managed by the network control device in a centralized manner, or may be managed by the node devices in a distributed manner.

According to the present exemplary embodiment, in the optical path network system 200, a service failure period can be minimized by dynamically allocating an optical path or performing backup in the event of failure at high speed, while a reduction in power consumption is achieved. These reductions in power consumption and in service failure period (a reduction in startup period) are also realized through coordination between the network control device and the node devices.

Hereinafter, regarding the second exemplary embodiment, a description will be given of a configuration and control to realize a reduction in power consumption and a reduction in startup period, with reference to FIGS. 2B to 9.

### 2.2) Configuration of Node Device

FIG. 2B is a block diagram showing a configuration of a node device 201 in an optical path network system 200-1 according to the second exemplary embodiment.

The optical path network system 200-1 that is the optical communication network system according to the second exemplary embodiment includes node devices 201, a network control device 270 responsible for control of the entire network, and a client device 260 for a user to receive services.

The network control device 270 at least has optical path route information 271 for changing optical paths from time to time and a node state storage section 272 that stores the states of node devices connecting to the network. The network control device 270 dynamically determines to add/delete an optical path by using the optical path route information 271 and node state information in the node state storage section 272 and instructs the node devices 201 to do so. In the present exemplary embodiment, each node device 201, upon receiving the instruction to add/delete an optical path from the network control device 270, dynamically performs control of optical path routes, considering by itself a reduction in power consumption and a reduction in startup period. The dynamic control of optical path routes by each node device 201, in total, contributes to a reduction in power consumption of the entire optical path network system 200-1 and a reduction in service failure period.

The node device 201 according to the second exemplary embodiment includes a plurality of optical transceivers 210, a power consumption control section 220, a node control section 230, an optical fiber network/optical switch 240, and a node internal power supply 250.

### (Optical Transceiver)

In the node device 201, the plurality of optical transceivers 210 are disposed. Each optical transceiver 210 includes a mode change section 211, an OE/EO control section 212, and a control circuit section 213 controlling them, and further includes a client-side input/output section 214 and a network-side optical transceiver 215 which are controlled by the control circuit section 213. The client-side input/output section 214 is connected to the client device 160. Note that the control circuit section 213 includes a conversion circuit for handling transmission schemes different between the client side and the network side, a circuit for correcting errors and compensating dispersion occurring in transmission on the network side, a circuit for synchronizing clocks on the client side and the network side, and the like. The network-side optical transceiver 215 is a section for transmitting/receiving optical signals to/from the network and is connected to the optical fiber network/optical switch 240 through optical fiber. This optical transceiver 210 is formed as a card in itself and is detachable by inserting/removing the card into/from the node device 201 as necessary. However, the optical transceiver 210 according to the present exemplary embodiment is not limited to the form of a detachable card but may have a form, for example, fixedly incorporated in the node device 201.

Note that power supply to the optical transceivers 210 is made from the node internal power supply 250. To power lines inside the optical transceiver 210, a power switch is connected that powers on or off each internal block as necessary. The power switch is connected to the mode change section 211 and performs ON/OFF control depending operation modes including multiple levels of standby mode. For this power switch, a relay switch or FET (Field Effect Transistor) provided on a circuitry of the optical transceiver 210 can be used. Moreover, since a function of powering off unused part through electronic control is added to some of current electronic circuit products such as LSI and FPGA (Field Programmable Gate Array), a reduction in power consumption can be partly achieved by the control circuit section 213, by using such a function.

### (Optical Fiber Network/Optical Switch)

The fiber network/optical switch 240 is a direction selector for selectively connecting optical fiber lines connected to the network-side optical transceivers 215 and directions A, B, and C to each other. Note that the number of directions is not limited to three.

### (Node Control Section)

The node control section 230 controls the entire node device 201. The node control section 230 at least has optical path route information 231 and controls optical path connections through the optical transceivers 210, in accordance with optical path route information indicated by the network control device 270. In the optical path connection control, the node control section 230 refers to the current usage states of the optical transceivers 210 managed by the power consumption control section 220. Note that a description of functions of the node control section 230 other than the functions characteristic to the present exemplary embodiment will be omitted.

### (Power Consumption Control Section)

The power consumption control section 220 has various functions such as, while reducing power consumption of the node device 201, promptly responding to an instruction to add/delete an optical path and also reducing a period of service failure to the client device 260 in the optical path network system 200-1 by using a backup or the like in the event of failure. To implement these functions, the power consumption control section 220 has data as described below.

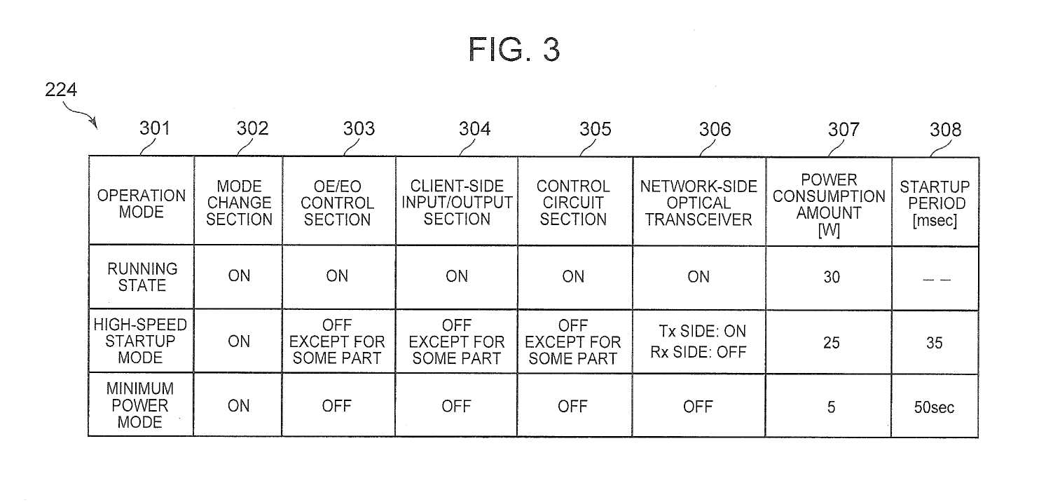

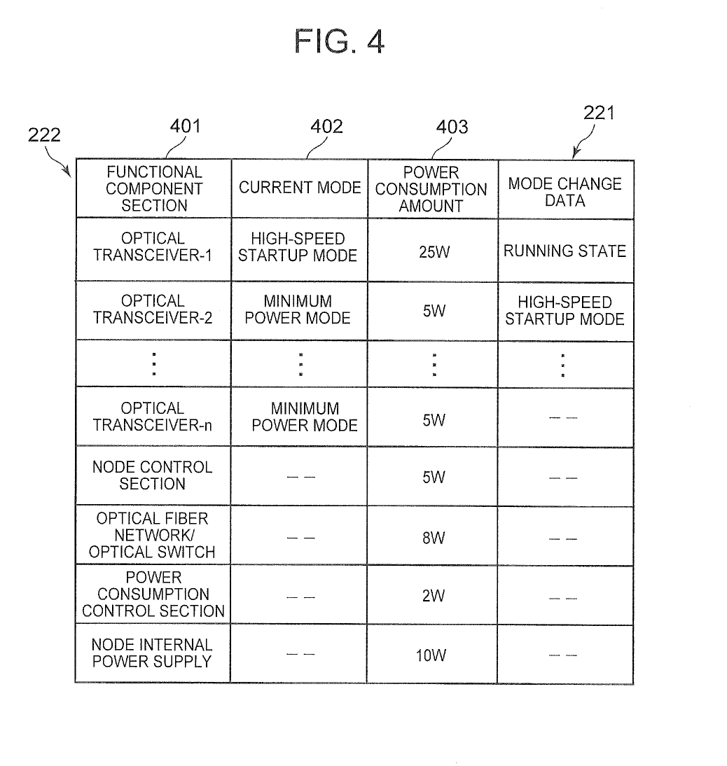

The power consumption control section 220 has an operation mode data base (DB) 224 and a usage state table 222. The operation mode DB 224 stores operation mode data that defines whether or not to supply power to each functional block in each operation mode of the optical transceiver 210 (see FIG. 3). The usage state table 222 stores a current operation mode of each optical transceiver 210 and an amount of power consumption of each functional component section (block) in the node device, and can associate mode change data 221 with each optical transceiver (see FIG. 4). High-speed-startup-mode optical transceiver count data 223 is the number of optical transceivers 210 in a high-speed startup mode in which high-speed startup is possible although power consumption is large. The mode change data 221 is date indicating which operation mode the current operation mode of each optical transceiver 210 should be changed to, based on references to the above-mentioned data indicating the current usage states and the optical path route information 231.

Note that in the present exemplary embodiment, the high-speed-startup-mode optical transceiver count data 223 is determined correspondingly to the number of directions from the fiber network/optical switch 240. Moreover, the optical path route information 231 in the node control section 230 and each data in the power consumption control section 220 can make access to each other. Furthermore, the node control section 230 and the power consumption section 220 each are connected to all of the optical transceivers 210 disposed in the node device and control optical path setting and operation modes.

### (Node Internal Power Supply)

The node internal power supply 250 supplies power to the functional component sections inside the node device 201. As described above, power supply to each functional component section is turned on or off in accordance with the operation mode data defined in the operation mode DB 224.

Hereinabove, the configuration of the node device 201 has been described in detail. However, each component part in the drawings are well known to those ordinarily skilled in the art and is not directly related to the functions characteristic to the present exemplary embodiment, and therefore detailed configurations thereof are omitted. Moreover, disposed positions of the node control section 230, the power consumption control section 220, and the mode change section 211 are not limited to the configuration as depicted in the drawing. For example, it is possible to make a form in which the node control section 230 and the power consumption control section 220 are integrated into one unit to perform control. Furthermore, although the mode change section 211 is disposed on the optical transceiver 210, it may be disposed on the power consumption control section 220 side. In addition, there is no restriction on the disposed position of the storage section for each data.

### 2.3) Data Structure

Hereinafter, structures of characteristic data used in the second exemplary embodiment will be described.

### (Structure of Operation Mode DB)

FIG. 3 is a diagram showing a structure of the operation mode DB 224 on the optical transceiver according to the second exemplary embodiment.

Referring to FIG. 3, a field 301 indicates operation modes including the plurality of standby modes which the optical transceivers 210 of the second exemplary embodiment are set in. Fields 302 to 306 indicate whether or not to permit to supply power to respective functional component sections, determined correspondingly to each operation mode 301. A field 307 indicates amounts of power consumption in the respective power supply states of the operation modes 301. A field 308 indicates startup periods corresponding to the individual operation modes 301. In the second exemplary embodiment, three modes are provided for the operation modes. One is an ordinary operational mode (running state) in which power supply is turned on for all of the functional component sections. Further, two modes, a high-speed startup mode and a minimum power mode, are provided as standby modes in which power consumption is reduced.

In the high-speed startup mode, the mode change section 211 and a transmission (Tx) side of the network-side optical transceiver 215 are powered on, while a reception (Rx) side of the network-side optical transceiver 215 is powered off because it can start up at high speed. The OE/EO control section 212, the client-side input/output section 214, and the control circuit section 213 are powered off except for a partial function, thereby reducing power consumption. The partial function is, for example, a part for maintaining clock synchronization between the client side and the network side that takes time in startup operation. Thus, power consumption during the high-speed startup mode can be reduced to 25 W, compared to 30 W in the ordinary operational mode. Moreover, time taken to transition from standby in the high-speed startup mode to the ordinary operational mode was 35 msec, achieving high-speed startup shorter than 50 msec. In the minimum power mode, only the mode change section 211 is powered on, and all the other functional sections are powered off. Thus, it is sufficient to supply minimum power to the optical transceiver 210, and power consumption was able to be reduced to 5 W. However, the startup period was 50 seconds, meaning slow. For example, it is also possible to allow those in the high-speed startup mode to stand by in the ordinary operational mode.

Note that regarding the operation modes of the optical transceiver 210, those described above are examples, and the operation modes may be set with consideration given to necessary startup periods and power consumption at appropriate times.

### (Structures of Usage Status Table and Mode Change Data)

FIG. 4 is a diagram showing respective structures of the usage state table and the mode change data on the optical transceivers according to the second exemplary embodiment.

Referring to FIG. 4, the usage state table 222 is a table storing a current operation mode (current mode) 402 and a power consumption amount 403 during this operation mode for each functional component section 401. For example, a first optical transceiver-1 is in the high-speed function mode and its power consumption amount is 25 W, and second and n-th optical transceivers-2 and -n are in the minimum power mode and their power consumption amount is 5 W. Thereafter, stored are a power consumption amount of 5 W of the node control section 230, a power consumption amount of 8 W of the optical fiber network/optical switch 240, and so on.

The mode change data 221 stores operation modes which the function component sections 401 are instructed to transition to next. For example, for the first optical transceiver-1, transition from the high-speed function mode to the running state is stored, and for the second optical transceiver-2, transition from the minimum power mode to the high-speed function mode is stored.

Note that the power consumption amounts of the individual functional component sections shown in FIG. 4 are examples and are not restrictive.

### (Number of Optical Transceivers in High-Speed Startup Mode)

In calculating reallocation of all optical transceivers 210 in the node device 201, the power consumption control section 220 is based on the condition that N optical transceivers in the high-speed startup mode are preferentially allocated. The N optical transceivers 210 in the high-speed startup mode are allocated such that “N/the number of directions” optical transceivers are allocated for each direction. In the present exemplary embodiment, N is equal to the number of directions from the node device 201. That is, if there are three directions A to C as in FIG. 2B, three optical transceivers 210 in the high-speed startup mode are allocated such that one stands by for each direction.

As shown in FIG. 3, the startup period of the optical transceiver 210 in the high-speed startup mode is 35 msec, which sufficiently meets the challenging necessity to restrict the service interruption period in the event of failure occurrence to the minimum, for example, 50 msec as a target, while it is also possible to reduce the amount of power consumption. Moreover, even if requests for path setting in the individual directions concurrently occur, it is not only possible to perform optical path setting in all of the directions at high speed, but it is easy for the power consumption control section 220 to perform control and so it is also possible to reduce power consumption of the control section itself. Furthermore, since each node device 201 performs control to reduce the amount of power consumption and to speed up the startup period by itself, it is possible to achieve power saving and high-speed startup without imposing a load on the network control device 270.

### 2.4) System Operation

Next, a description will be given of an operation procedure of the optical communication network system according to the second exemplary embodiment configured as described above, following sequence diagrams of operations of the individual functional component sections.

### 2.4.1) Operation at the Time of Setting Up an Optical Path

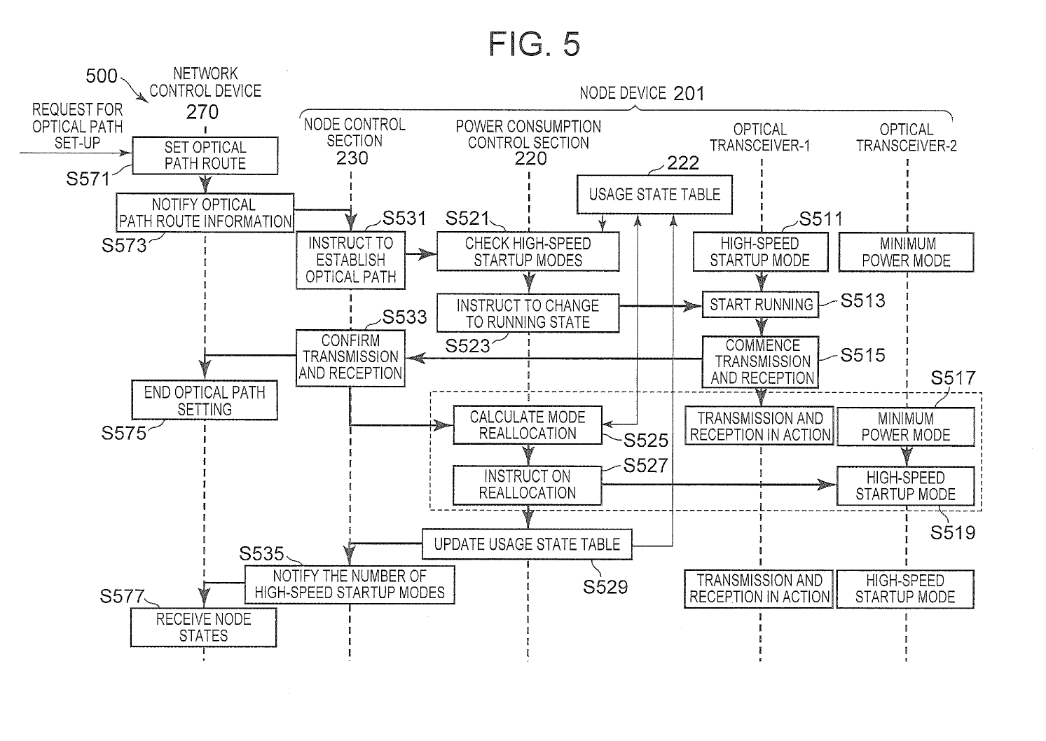

FIG. 5 is a sequence diagram showing an operation procedure 500 at the time of setting up an optical path, at the optical path network system 200-1, which is the optical communication network system according to the second exemplary embodiment, and at the node device 201. Note that in FIG. 5, reference signs are given so that an operation procedure of each functional component section can be seen. Moreover, for simplification, FIG. 5 shows minimum transactions between the network control device 270 and the node control section 230.

The network control device 270, upon receiving a request to set up an optical path, sets an optical path route indicating which nodes are passed through (S571). Then, optical path route information indicating what wavelength of signal should be transmitted and received in which direction, is notified as a path setting instruction to node devices 201 that are present along the optical path route and employ an OE/OE section (S573). In response to the instruction, the node control section 230 outputs an instruction to the power consumption control section 220 (S531) to check the usage state table 222 for optical transceivers 210 in the high-speed startup mode and select an optical transceiver 210 to change to the running state (S521). The power consumption control section 220 sends an instruction to change to the running state to the selected optical transceiver 210 (S523). Thus, the selected optical transceiver 210 (the optical transceiver-1 in FIG. 5), from the high-speed startup mode (S511), starts running (S513). Thereafter, an optical transceiver of a node device at the other end of this optical path has started up, and path setting at a node device in between has been established, when transmission and reception are commenced (S515).

When the node control section 230 has confirmed transmission and reception over the optical path (S533), the node control section 230 notifies the network control device 270 of completion of the path setting, and the network control device 270 ends the optical path setting (S575). At the same time, the power consumption control section 220 performs calculation concerning reallocation of all optical transceivers in the node device 201 (S525) and instructs optical transceivers to reset modes in accordance with a result of the reallocation (S527). The optical transceiver 210 (the optical transceiver-2 in FIG. 5) that has received the instruction on change, changes its operation mode from the minimum power mode (S517) to the high-speed function mode (S519).

Finally, the operation mode of each optical transceiver 210 is re-registered in the usage state table 222 to update (S529). Then, the node control section 230 notifies the network control device 270 of the number of optical transceivers in the high-speed startup mode (S535), and the network control device 207 registers node states with the node state storage section 272 (S577) and then waits for next path route setting. Thereby, the node states are notified across the entire network.

Through the above-described sequence in FIG. 5, even when a request to set a path in each direction concurrently occurs, it is not only possible to set optical paths in all directions at high speed, but it is easy for the power consumption control section 220 to perform control and so it is also possible to reduce power consumption of the control section itself. Moreover, since power consumption control at each node device 201 is independently performed in a distributed manner, improvement is also made with respect to a load on the network control device 270 and communication traffic between the network control device 270 and the node devices 201.

### 2.4.2) Operation at the Time of Setting Down an Optical Path

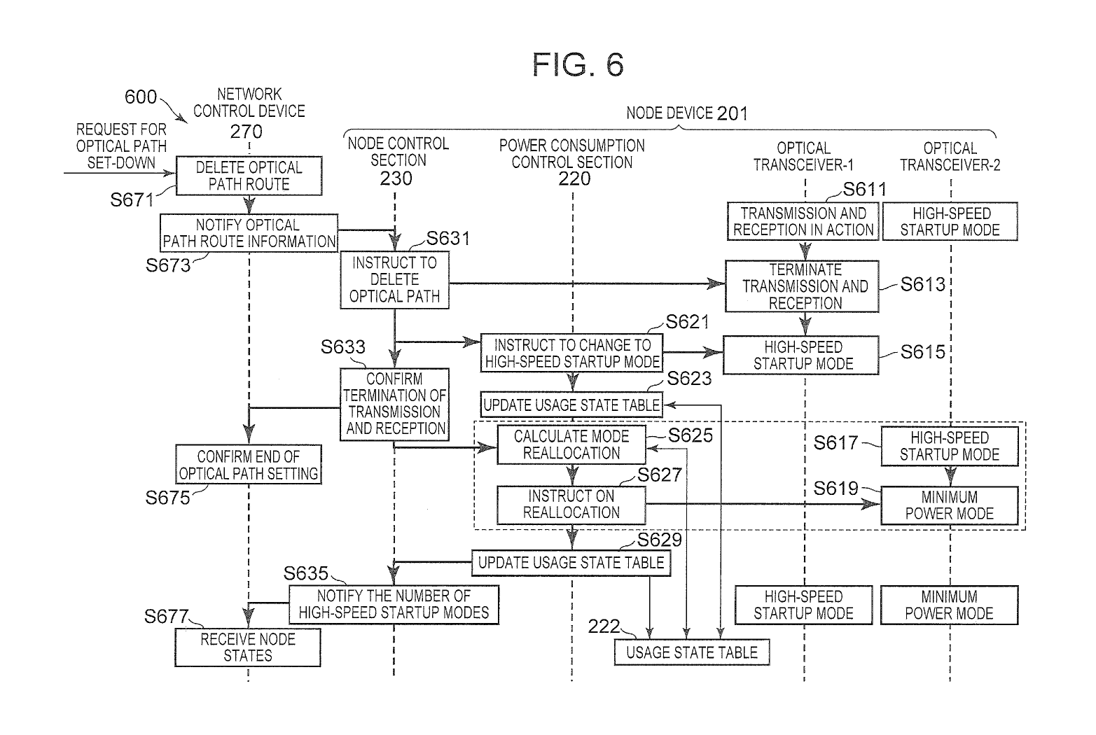

FIG. 6 is a sequence diagram showing an operation procedure 600 at the time of setting down an optical path, at the optical path network system 200-1, which is the optical communication system according to the second exemplary embodiment, and at the node device 201.

The network control device 270, upon receiving a request to set down an optical path, determines which nodes an optical path route to delete passes through (S671) and notifies optical path route information for setting down an optical path to node devices 201 that are present along the optical path route (S673). Upon receiving an instruction to set down the optical path from the network control device 270, the node control section 230 of the node device 201 promptly instructs an optical transceiver 210 (the optical transceiver-1 in FIG. 6) which the optical path to be set down passes through to turn off a notified channel (to delete the optical path) (S631). The optical transceiver-1, upon receiving the instruction to delete the optical path, changes from transmission and reception in action (S611) to termination of transmission and reception (S613). Moreover, the power consumption control section 220, upon occurrence of the support to delete the optical path, instructs the optical transceiver-1 to change to the high-speed startup mode (S621), whereby the optical transceiver-1 that has terminated transmission and reception changes straightaway to the high-speed startup mode (S615). The power consumption control section 220, in accordance with the change of the optical transceiver-1 from the ordinary operational state to the high-speed startup mode, updates the usage state table 222 (S623).

When the node control section 230 has confirmed the termination of transmission and reception (S633), the power consumption control section 220 calculates reallocation of the operation modes of the optical transceivers 210 (S625) and instructs to change the setting of each optical transceiver 210 (S627). Here, since the optical transceiver-1 has joined the high-speed startup mode, the optical transceiver-2 that has been standing by in the high-speed startup mode is changed to the minimum power mode (S619).

Finally, the changed states are registered in the usage state table (S629), and the number of optical transceivers in the high-speed startup mode after change is notified to the network control device 207 (S635). The network control device 270 registers the number of the high-speed startup modes with the node state storage section 272 as node states (S677) and thus notifies it across the entire network.

Note that the sequences of setting the optical transceivers 210 in the node device 201 at the times of setting up and setting down an optical path in FIGS. 5 and 6 are only examples and are not restrictive. For example, the mode reallocation calculation performed by the power consumption control section 220 can be performed by the node control section 230. Moreover, rewriting of the usage state table 222 and the like and notification to the entire network can also be performed immediately after the operation mode of each optical transceiver has changed. Thereby, it is possible for the entire network to recognize node states in real time, and it is possible to perform control based on correct information in path setting in the entire network.

### 2.5) Hardware Configuration

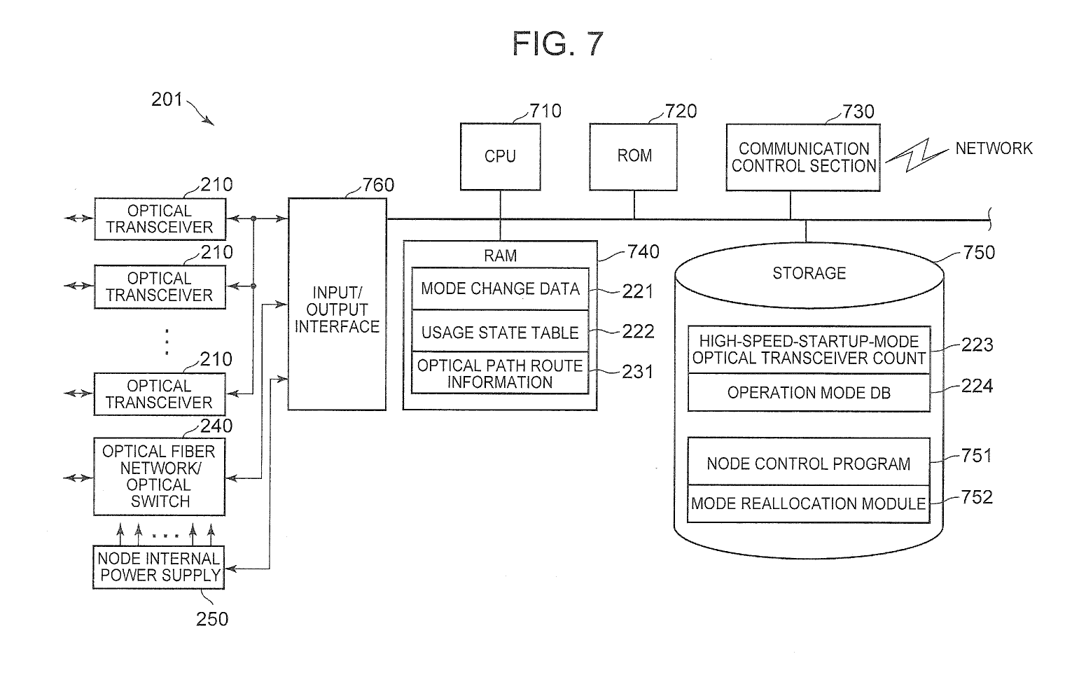

FIG. 7 is a block diagram showing a hardware configuration of the node device 201 according to the second exemplary embodiment.

Referring to FIG. 7, a CPU (Central Processing Unit) 710 is a processor for operation control and implements each functional component section in FIG. 2B by executing programs. A ROM (Read-Only Memory) 720 stores fixed data and programs such as initial data and programs. A communication control section 730 communicates with external devices, such as the network control device 270, through a network. Communication can be wired or wireless.

A RAM 740 is a random access memory that is used as a work area for temporary memory by the CPU 710. In the RAM 740, areas for storing data necessary to implement the present exemplary embodiment are secured. In the respective areas, the mode change data 221, the usage state table 222, and the optical path route information 231 shown in FIG. 2B are stored.

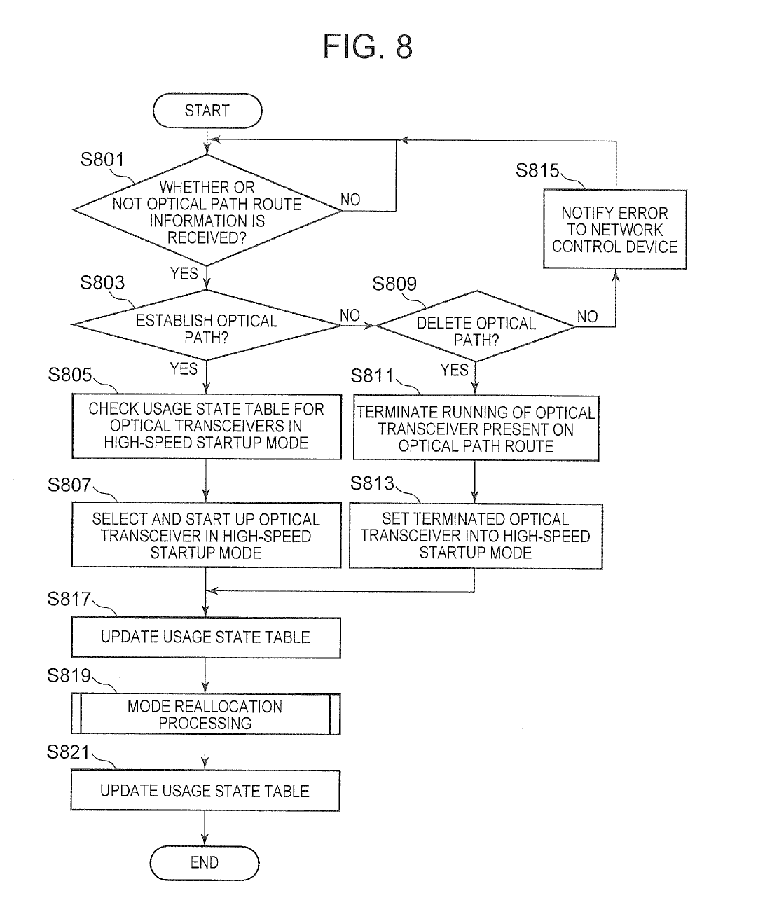

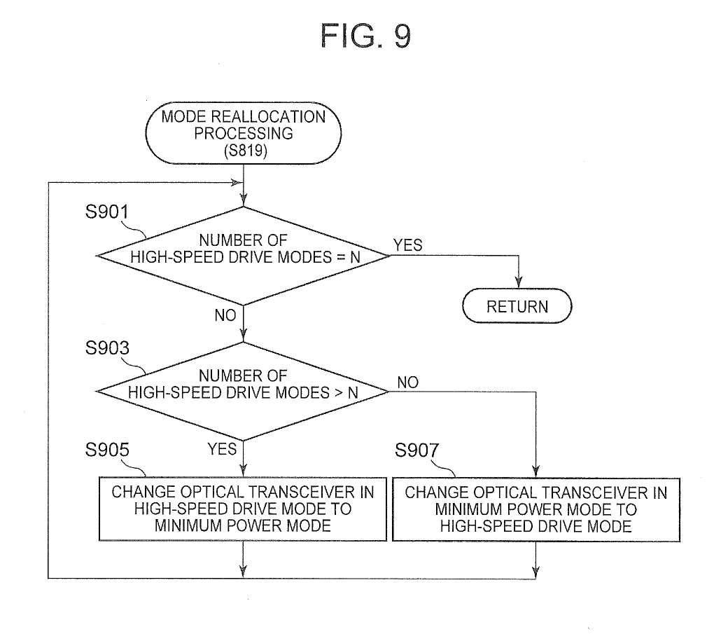

A storage 750 is a large-capacity storage device that stores databases, various parameters, and programs to be executed by the CPU 710 in a nonvolatile manner. In the storage 750, following data or programs necessary to implement the present exemplary embodiment are stored. For data, the high-speed-startup-mode optical transceiver count data 223 and the operation mode DB 224 shown in FIG. 2B are stored, and for programs, a node control program 751 (see FIG. 8) indicating an optical path control procedure of the entire node device and a mode reallocation module 752 (see FIG. 9) for reallocation of the operation modes of optical transceivers are stored.

An input/output interface 760 is an interface for receiving as inputs data necessary for control by the CPU 710 and outputting control signals. Interfaces with the optical transceivers 210, the optical fiber network/optical switch 240, and the node internal power supply 250 are made by the input/output interface 260.

Note that FIG. 7 only shows the data and programs essential to the present exemplary embodiment and does not show general data or programs such as OS (Operating System).

### 2.6) Optical Path Control Procedure

FIG. 8 is a flowchart showing an optical path control procedure of the node device 201 according to the second exemplary embodiment. This optical path control procedure is executed by the CPU 710 of the node device 201 in FIG. 7 using the RAM 740 and implements the control functions shown in FIG. 2B.

First, in Step S801, it is determined whether or not optical path route information is received from the network control device 270. Note that the received optical path route information includes optical path set-up (establishment) and optical path set-down (deletion). In Steps S803 and S809, it is determined whether the information is for optical path set-up (establishment) or for optical path set-down (deletion). If the information is neither for optical path set-up (establishment) nor for optical path set-down (deletion), an error is notified to the network control device 270 in Step S815, and the process goes back to Step S801. Then, processing by the network control device 270 such as retransmission of optical path route information is awaited.

If the optical path route information is for optical path set-up (establishment), the process goes to Step S805, where the usage state table 222 is checked for optical transceivers in the high-speed startup mode. Next, in Step S807, an optical transceiver selected from among the optical transceivers in the high-speed startup mode is started up. On the other hand, if the optical path route information is for optical path set-down (deletion), the process goes to Step S811, where running of an optical transceiver present on an optical path route designated by the optical path route information is terminated. Next, according to the present exemplary embodiment, in Step S813, the optical transceiver that has terminated transmission and reception is set in the high-speed startup mode.

In Step S817, the usage state table 222 is updated according to a change in the usage state of the optical transceiver that has been changed due to the optical path set-up (establishment) or optical path set-down (deletion). In Step S819, mode reallocation processing is performed based on the changed usage state table 222 and the high-speed-startup-mode optical transceiver count 223. The mode reallocation processing is shown in FIG. 9 in detail. In Step S821, the usage state table 222 is updated according to a change in the usage state of an optical transceiver updated by the mode reallocation processing.

### 2.7) Mode Reallocation Processing Procedure

FIG. 9 is a flowchart showing a procedure of the mode reallocation processing (S819 in FIG. 8) of the node device 201 according to the second exemplary embodiment.

First, in Step S901, it is determined whether or not the current number of optical transceivers in the high-speed startup mode is N that is designated as the high-speed-startup-mode optical transceiver count 223. If the number is N, reallocation is not performed, and the processing is ended.

If the number of optical transceivers in the high-speed startup mode is not N, then in Step S903, it is determined whether the number of optical transceivers in the high-speed startup mode is larger than N, or smaller than N. If the number is larger than N, the process goes to Step S905, where an optical transceiver in the high-speed startup mode is changed to the minimum power mode so that the number of optical transceivers in the high-speed startup mode will be N. On the other hand, if the number is smaller than N, the process goes to Step S907, where an optical transceiver in the minimum power mode is changed to the high-speed startup mode so that the number of optical transceivers in the high-speed startup mode will be N.

Note that in the second exemplary embodiment, reallocation is performed such that an optical transceiver in the high-speed startup mode will exist in each direction, but a description thereof is omitted here. A procedure for such reallocation that at least one optical transceiver exists in each direction is easy.

### 3. Third Exemplary Embodiment

An optical path network system and a node device according to a third exemplary embodiment of the present invention have the same basic configurations as those of the second exemplary embodiment, but mode reallocation calculation at the power consumption control section 220 is different. According to the third exemplary embodiment, for a parameter of the amount of traffic at a node, the total number of paths set in individual directions is used.

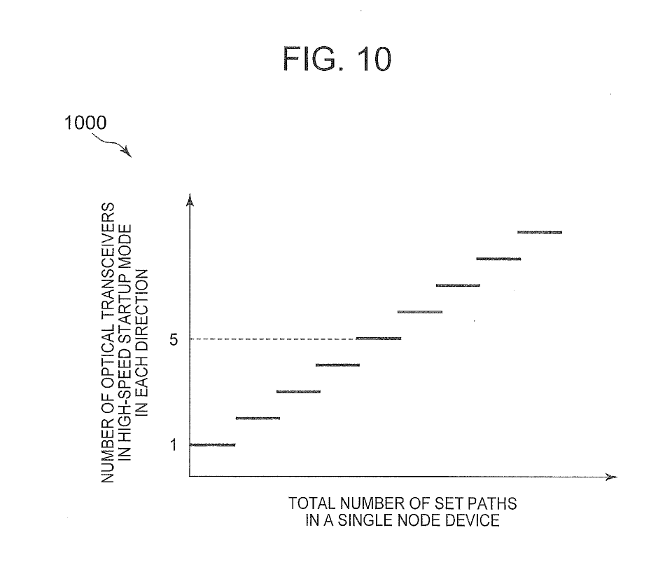

FIG. 10 shows a relationship between the total number of paths set in individual directions and the number of optical transceivers 210 then preferentially standing by in the high-speed startup mode. As the total number of set paths becomes larger, optical path addition setting and deletion setting increase. Therefore, the larger the total number of set paths is, the more the high-speed startup modes are allocated, whereby it is possible to set up and delete optical paths at high speed even when a network is congested.

Note that when the number of optical transceivers 210 is smaller than the number of optical transceivers desired to be set in the high-speed startup mode, an algorithm is employed in which the total number of paths set in each direction is compared to each other and priority of allocation is placed on a direction where more paths are set. Thereby, it is possible to allow the node device to respond to the usage state of a network, and to arrange optical transceivers 210 that can start up at high speed even when the network is congested.

### 4. Fourth Exemplary Embodiment

An optical path network system and a node device according to a fourth exemplary embodiment of the present invention have the same basic configurations as those of the second exemplary embodiment, but mode reallocation calculation at the power consumption control section 220 is different. According to the fourth exemplary embodiment, for a parameter of the amount of traffic at a node, a change per unit time in the total number of paths set in individual directions is used.

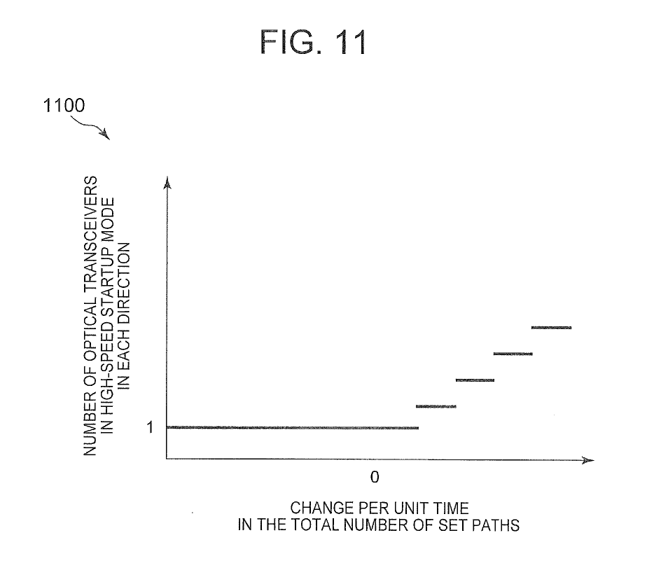

FIG. 11 shows a relationship between a change per unit time in the total number of paths set in individual directions and the number of optical transceivers 210 then preferentially standing by in the high-speed startup mode. Referring to FIG, 11, as a positive change in the number of paths becomes larger, the number of optical transceivers preferentially standing by in the high-speed startup mode is increased. On the other hand, when a change in the number of paths is negative, the number of optical transceivers 210 preferentially standing by in the high-speed startup mode is kept to be small. It is particularly preferred that the number is the same as when a change is zero. This is because optical path set-down itself can be handled by turning off transmission and reception of a running optical transceiver 210 and therefore it is unnecessary to have an unused optical transceiver 210 stand by in the high-speed startup mode. Thus, it is possible to have more unused optical transceivers stand by in a mode with lower power consumption, and to achieve even more power-saving operation of the node device.

Note that in the mode reallocation calculations according to the third and fourth exemplary embodiments, to eliminate an influence of an instantaneous change in path setting, it is also possible that path setting information for a constant period is stored in a memory and noise is eliminated by approximation through averaging or the like and a spectrum of discrete Fourier transform. Thereby, it is possible to prevent an unnecessary change of standby modes due to an instantaneous change in the state of a network. Moreover, the number of optical transceivers 210 in the high-speed startup mode is not unnecessarily increased, and even more power-saving operation of a network node can be achieved.

### 5. Fifth Exemplary Embodiment

In the above-described second to fourth exemplary embodiments, the power consumption and startup period of optical transceivers are reduced. In a fifth exemplary embodiment, a reduction in power consumption and a reduction in startup period can be made not only for optical transceivers but also for another functional component section of a node device, for example, an aggregator for connecting the optical transceivers to individual directions. According to the present exemplary embodiment, a state capable of high-speed startup can also be realized for the aggregator that is a direction selector operating in coordination with the optical transceivers, and an even more reduction in power consumption of a node device can be achieved by controlling the aggregator together with the optical transceivers.

### 5.1) Configuration of Node Device

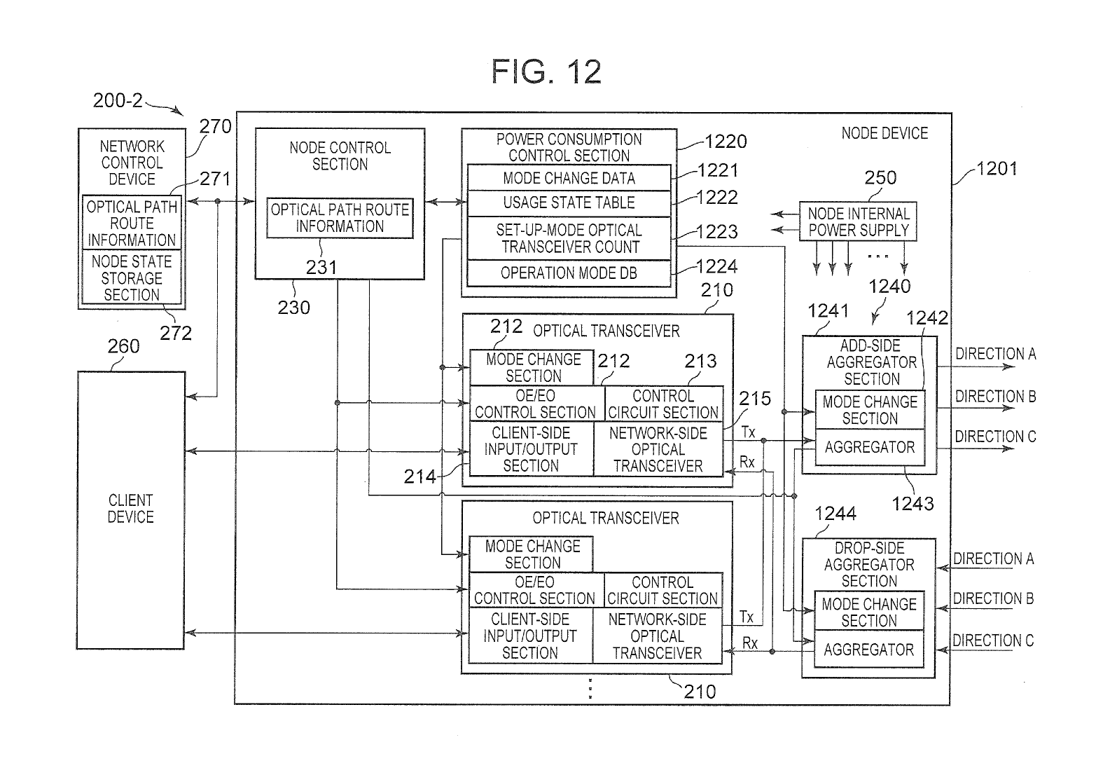

FIG. 12 is a block diagram showing a configuration of a node device 1201 in an optical path network system 200-2 according to the fifth exemplary embodiment. A configuration of an optical transceiver 210 in the node device according to the fifth exemplary embodiment is basically similar to those of the second to fourth exemplary embodiments although the numbers of operation modes are different. The fifth exemplary embodiment is different from the second exemplary embodiment in the point that a plurality of different standby modes are provided for an optical fiber network/optical switch similarly to the optical transceiver 210. Hereinafter, a description will be given of part different from the second exemplary embodiment, and a description of similar functional component sections will be omitted.

### (Aggregator Section)

In the fifth exemplary embodiment, an aggregator section 1240 is used for the optical fiber network/optical switch, which is a direction selector. This aggregator section 1240 is a device for aggregating x of all M (x<M) optical transceivers 210 and implementing free input/output of light in a plurality of network directions. This aggregator section 1240 has different device configurations for adding and dropping optical signals to/from a network. That is, an ADD-side aggregator section 1241 and a DROP-side aggregator section 1244 are disposed on a transmission side (Tx side of a network-side optical transceiver 215) and a reception side (Rx side of the network-side optical transceiver 215), respectively.

The ADD-side and DROP-side aggregator sections 1241 and 1244, similarly to the optical transceiver 210, have a plurality of operation modes, which are changed by a mode change section 1242. The mode change section 1242, according to the operation modes, controls a power switch and a power-saving mechanism in each of the ADD-side and DROP-side aggregator sections 1241 and 1244, thereby setting an appropriate mode. The mode change section 1242 is connected to a power consumption control section 1220 and implements an operation mode change linked with the optical transceivers 210. Moreover, the ADD-side and DROP-side aggregator sections 1241 and 12444 are connected to a node control section 230, and aggregator operation is controlled by the node control section 230 during running. The ADD-side and DROP-side aggregator sections 1241 and 1244 are connected to the same x optical transceivers 210 and are configured to concurrently perform the same operations when a path is set, whereby control is simplified. Note that although the ADD-side and DROP-side aggregator sections 1241 and 1244 for e.g., x=4 is used in the present exemplary embodiment, the value of x is not restrictive.

In the fifth exemplary embodiment, the aggregator section 1240 is used in place of the optical fiber network/optical switch 240 of the second and fourth exemplary embodiments. However, even if other equipment such as an amplifier like EDFA (Erbium Doped-Fiber Amplifier) or an optical monitor is used, power saving by similar control can also be achieved.

### (Power Consumption Control Section)

The node device 1201 includes the power consumption control section 1220. The power consumption control section 1220, while reducing the power consumption of the node device 1201, promptly responds to an instruction to add/delete an optical path and also reduces a period of service failure to a client device 260 in the optical path network system 200-2 by using a backup or the like in the event of failure.

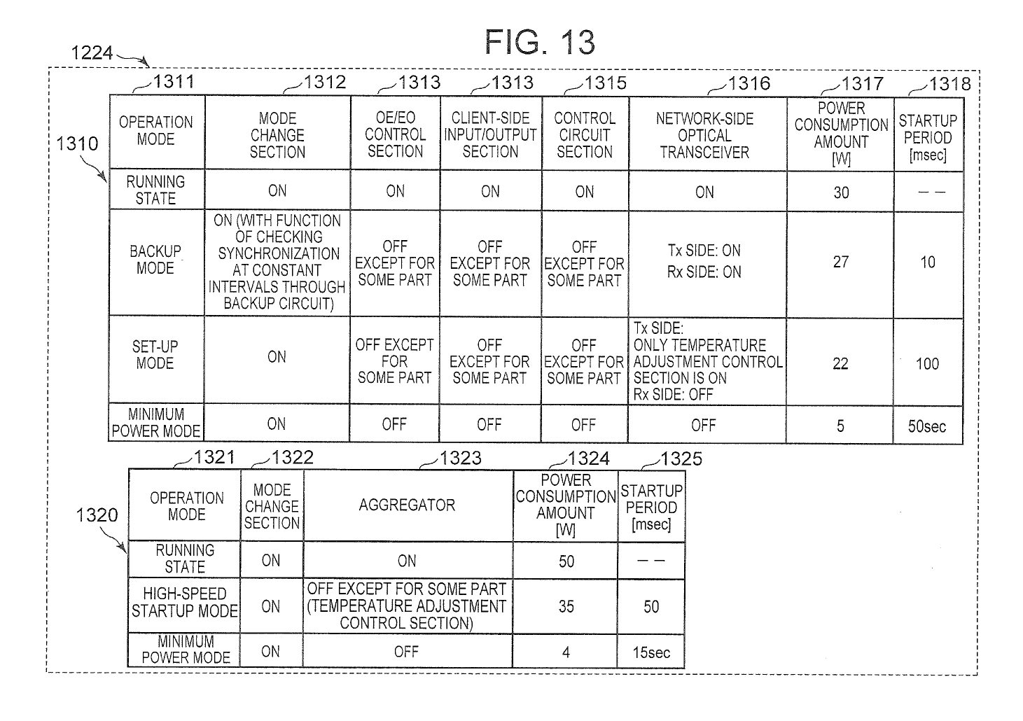

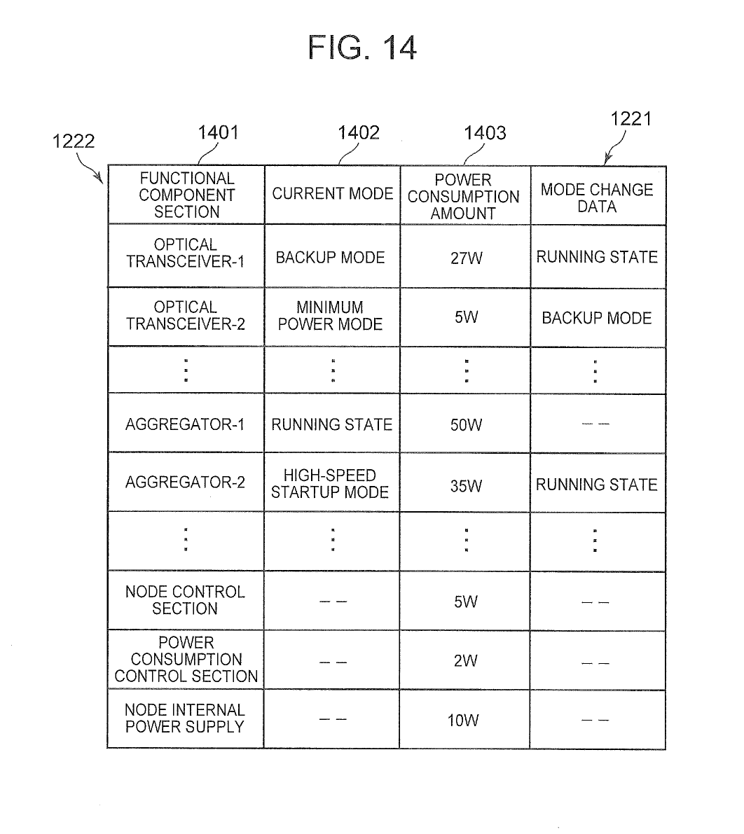

The power consumption control section 1220 has an operation mode database (DB) 1224 and a usage state table 1222. The operation mode DB 1224 stores operation mode data that defines whether or not to supply power to each functional block in each operation mode of the optical transceiver 210 (see FIG. 13). The usage state table 1222 stores a current operation mode of each optical transceiver 210 and an amount of power consumption of each functional component section in the node device and can associate mode change data 1221 with each optical transceiver (see FIG. 14). High-speed-startup-mode optical transceiver count data 1223 is the number of optical transceivers 210 in the high-speed startup mode in which power consumption is large but high-speed startup is possible. The mode change data 1221 is data indicating which operation mode the current operation mode of each optical transceiver should be changed to, based on references to the above-mentioned data indicating the current usage state and optical path route information 1231.

### 5.2) Data Structure

Hereinafter, structures of characteristic data newly used in the fifth exemplary embodiment will be described.

### 5.2.1) Operation Mode DB on Optical Transceiver

FIG. 13 is a diagram showing a structure of the operation mode DB 1224 on the optical transceiver according to the fifth exemplary embodiment. An operation mode table 1310 shown on the top of FIG. 13 is applied to the optical transceivers 210. As in FIG. 3 of the second exemplary embodiment, data indicating states of supplying power to respective functional component sections shown in fields 1312 to 1316, as well as power consumption amounts 1317 and startup periods 1318, are stored in association with individual modes shown in a field 1311.

For the operation modes 1311 provided for the optical transceivers 210, following 4 types are arranged. One is an ordinary operational mode, in which all functions are powered on. Further, three types, a backup mode, a set-up mode, and a minimum power mode, are provided for standby modes in which the amount of power consumption is reduced.

### (Backup Mode)

The backup mode is an operation mode specialized for high-speed startup of a backup circuit. When an optical path is set, a backup path is arranged at the same time. When a failure occurs in the optical path, the optical path is switched to the backup path at high speed, whereby a highly reliable network can be realized. In the backup mode, a function of constantly matching synchronization among nodes is provided. Therefore, in this backup mode, the network-side optical transceiver 215 is always powered on. At others including an OE/EO control section 212, a client-side input/output section 214, and a control circuit section 213, part for maintaining clock synchronization performed between the client side and the network side is powered on, and other functions are powered off.

To a mode change section 211, as shown in the field 1312, an instruction is made to cause the network-side optical transceiver 215 to perform transmission and reception for synchronization among backup circuits at constant intervals (here, every 10 seconds). The OE/EO control section 212, the client-side input/output section 214, and the control circuit section 213 are also configured to synchronize based on that synchronization so that synchronization among nodes is maintained. Note that part other than the functional part for maintaining synchronization is configured to be in an off state. Thus, power consumption in the backup mode was 27 W. The period taken to transition to the running state was 10 msec, achieving even higher-speed operation.

### (Set-Up Mode)

The set-up mode is a standby mode used when a new optical path is set up at high speed. In the set-up mode, only a temperature adjustment control section on a transmission (Tx) side of the network-side optical transceiver 215 is powered on, and other functions thereof are powered off. Power supply to the other functional component sections is configured to be the same as in the high-speed startup mode according to the second exemplary embodiment. Unlike the high-speed startup mode according to the second exemplary embodiment, since startup on the transmission (Tx) side of the network-side optical transceiver 215 takes 100 msec, it also takes 100 msec to transition from the set-up mode to the running state, but the power consumption was able to be reduced to 22 W.

### (Minimum Power Mode)

The minimum power mode is configured to have the same function as the minimum power mode according to the second exemplary embodiment in FIG. 3.

### 5.2.2) Operation Mode DB on Aggregator Section

An operation mode table 1320 shown on the bottom of FIG. 13 is applied to the aggregator section 1240. Data indicating states of supplying power to respective functional component sections shown in fields 1322 and 1323, as well as power consumption amounts 1324 and startup periods 1325, are stored in association with individual operation modes shown in a field 1321.

For the operation modes of the aggregator section 1240, three types are arranged. One is an ordinary operational mode, in which all functions are powered on. Further, two types, a high-speed startup mode and a minimum power mode, are provided for standby modes in which power consumption is reduced.

In the high-speed startup mode, control part other than a temperature adjustment section of an aggregator 1243 is powered off. The startup period is 50 msec, and the power consumption is 35 W. On the other hand, in the minimum power mode, only the mode change section 1242 is powered on, and the startup period is 15 sec while the power consumption is 4 W.

### 5.2.3) Usage State Table and Mode Change Data

FIG. 14 shows respective structures of a usage state table, total amounts of power consumption, and mode change data on the optical transceivers 210 and the aggregator sections 1240 according to the fifth exemplary embodiment.

Referring to FIG. 14, a table 1222 is the usage state table on the optical transceivers and the aggregator sections. The usage state table 1222 stores current operation modes in a current mode field 1402 and amounts of power consumption during the respective current modes in a power consumption amount field 1403, for individual functional component sections shown in a functional component section field 1401. For example, a first optical transceiver-1 is in the backup mode, with an amount of power consumption of 27 W, and a second optical transceiver-2 is in the minimum power mode, with an amount of power consumption of 5 W. Moreover, a first aggregator section-1 is in the running state, with an amount of power consumption of 50 W, and a second aggregator section-2 is in the high-speed startup mode, with an amount of power consumption of 35 W. Thereafter, stored are a power consumption amount of 5 W of the node control section 230, a power consumption amount of 2 W of the power consumption control section 1220, and so on.

The mode change data 1221 stores operation modes which the functional component sections 1401 should transition to next. For example, for the first optical transceiver-1, transition from the backup mode to the running state is stored, and for the second optical transceiver-2, transition from the minimum power mode to the backup mode is stored. Moreover, for the second aggregator section-2, transition from the high-speed startup mode to the running state is stored.

Note that the amounts of power consumption of the individual functional component sections shown in FIG. 14 are examples and are not restrictive.

### 5.2.4) Number of Optical Transceivers in Set-Up Mode

In calculation for reallocating all of the optical transceivers 210 and the aggregator sections 1240 in the node device 1201, the power consumption control section 1220 sets following conditions. For the backup mode, as many optical transceivers 210 as the number of set paths are allocated, and the set-up-mode optical transceiver count data 1223 is based on the condition that M optical transceivers in the set-up mode are preferentially allocated. For the number M of optical transceivers in the fifth exemplary embodiment, a value corresponding to a change per unit time in the total number of paths set in individual directions as shown in the fourth exemplary embodiment (FIG. 11) is used. Moreover, for the backup mode and the set-up mode, an algorithm is employed in which an optical transceiver connected to a running aggregator section is preferentially used.

The aggregator sections 1240 are reallocated as follows. An aggregator section 1240 to which an optical transceiver in the running state is connecting, shall be in the running state. An aggregator section 1240 to which no optical transceiver in the running state is connecting but an optical transceiver in the backup mode or the set-up mode is connecting when the above-described conditions for the optical transceivers is met, shall be in the high-speed startup mode. An aggregator section 1240 to which no optical transceiver in the backup mode or the set-up mode is connecting, shall be in the minimum power mode. In this manner, the number of aggregator sections (the number of direction selectors) in the minimum power mode is increased, whereby power saving can be achieved.

### 5.3) Operation of Optical Communication System

Next, a description will be given of an operation procedure of an optical communication system according to the fifth exemplary embodiment configured as described above, following sequence diagrams of operations of the individual functional component sections.

### 5.3.1) Operation at the Time of Setting Up an Optical Path

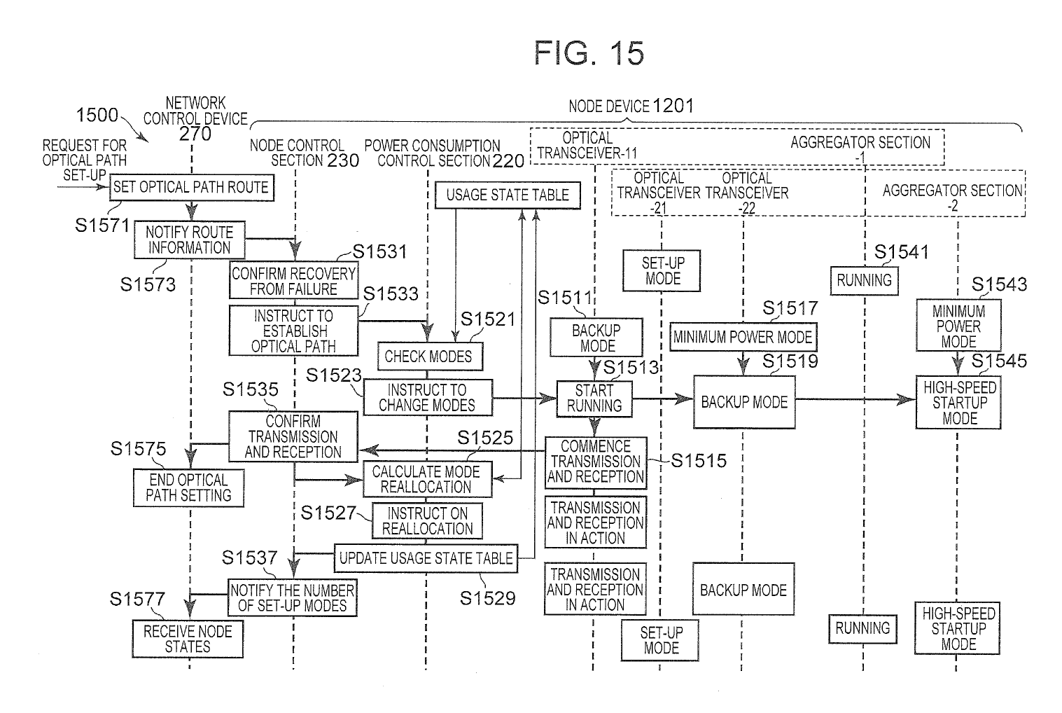

FIG. 15 shows an operation procedure 1500 at the time of setting up an optical path, at the optical path network system 200-2, which is the optical communication network system according to the fifth exemplary embodiment, and at the node device 1201. Note that in FIG. 15, reference signs are given so that an operation procedure of each functional component section can be seen. Moreover, for simplification, FIG. 15 shows minimum transactions between the network control device 270 and the node control section 230.

The network control device 270, upon receiving a request to set up an optical path, sets an optical path route indicating which nodes are passed through (S1571).

Then, optical path route information instructing what wavelength of signal should be transmitted and received in which direction is notified, as an instruction on path setting, to node devices 1201 that are present along the optical path route and employ an OE/EO section (S1573). Note that in FIG. 15, a description is given of a case where an optical path is set up to recover from a failure, but the same procedure applies when an optical path is newly set up.

The node control section 230 checks whether or not optical path set-up is for recovery from a failure (S1531) and instructs on path setting according to a result of the check (S1533). The power consumption control section 1220 selects an optical transceiver in the backup mode in case of recovery from a failure but selects an optical transceiver in the set-up mode in case of new set-up, based on information in the usage state table 1222. At the same time, an optical transceiver for backup corresponding to the selected path is also selected. Since illustrated here is a case of recovery from a failure, an optical transceiver-11 of an aggregator section-1 in the backup mode is selected as an optical transceiver to start up, and an optical transceiver-22 of an aggregator section-2 in the set-up mode is selected as an optical transceiver for backup (S1521). To these two selected optical transceivers-11 and -22, an instruction to change modes is sent from the power consumption control section 1220 (S1523). Upon receiving this instruction, the optical transceiver-11, from the backup mode (S1511), starts running (S1513). The optical transceiver-22, from the minimum power mode (S1517), changes to the backup mode (S1519). Thereafter, the node control section 230 performs direction and wavelength setting according to the instruction on path setting, on the optical transceivers 210 and the aggregator sections 1240 (not shown). Thereby, a path is set with a node device on the other end, and transmission and reception are commenced (S1515). Thereafter, when the node control section 230 has confirmed transmission and reception (S1535), the power consumption control section 1220, based on newly changed information within the node device 1201, calculates reallocation of the standby modes of the optical transceivers 210 and the aggregator sections 1240 (S1525) and makes an instruction on reallocation (S1527). Note that in the example shown in FIG. 15, no change is made due to reallocation.

For example, when all optical transceivers 210 connecting to the aggregator section-1 in running (S1541) have come in the backup mode or the set-up mode, the aggregator section-2 standing by in the minimum power mode is changed to the high-speed startup mode (S1543 S1545). Moreover, when an optical transceiver 210 connecting to an aggregator section in the high-speed startup mode is used to set up a path (not shown), the aggregator section in the high-speed startup mode is also concurrently changed to the running state. In this manner, power-saving modes are also applied to the aggregator sections 1240 in conjunction with the optical transceivers 210, whereby an even more reduction in power consumption can be achieved while high-speed startup is realized.

Finally, the operation mode of each optical transceiver is registered in the usage state table 1222 (S1529), the number of optical transceivers in the set-up mode is notified to the network control device 270 (S1537 S1577), and then a next instruction on path route setting is awaited.

### 5.3.2) Operation at the Time of Setting Down an Optical Path

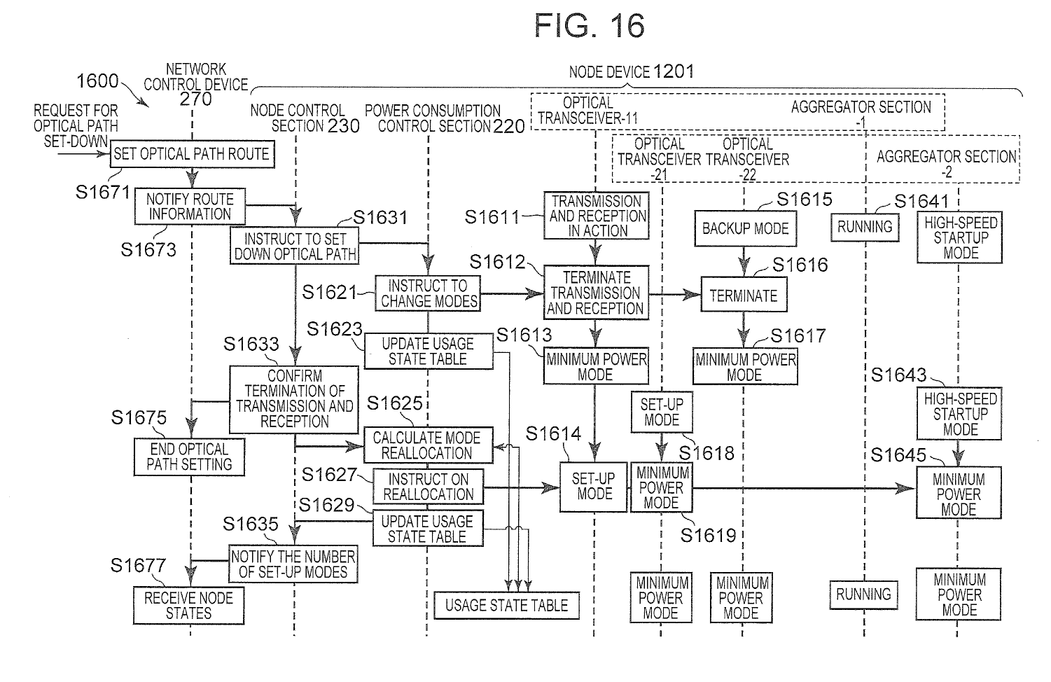

FIG. 16 shows an operation procedure 1600 at the time of setting down an optical path, at the node device 1201 in the optical path network system 200-2 according to the fifth exemplary embodiment.

The network control device 270, upon receiving a request to set down an optical path, sets which nodes an optical path route to delete passes through (S1671). Then, optical path route information for setting down an optical path is notified to node devices 1201 that are present along the optical path route (S1673). Upon receiving the instruction to set down the optical path from the network control device 270, the node control section 230 of the node device 1201 instructs an optical transceiver 210 (the optical transceiver-11 in FIG. 16) which the optical path to be set down passes through to turn off a notified channel, via the power consumption control section 1220 (S1631→S1621). The optical transceiver-11, upon receiving the instruction, changes from transmission and reception in action (S1611) to termination of transmission and reception (S1612). Here, the optical transceiver-11 that has terminated transmission and reception transitions straightaway to the minimum power mode (S1612→S1613). At the same time, the optical transceiver-22 for backup set in the backup mode (S1615) is terminated (S1616) to change to the minimum power mode (S1617). The power consumption control section 1220 changes the usage state table 222 in accordance with the transitions of operation modes of the optical transceivers-11 and -22 (S1623).

When the node control section 230 has confirmed the termination of transmission and reception (S1633), the power consumption control section 1220 calculates reallocation of the operation modes of the optical transceivers 210 and the aggregator sections 1240 (S1625) and instructs each optical transceiver 210 and aggregator section 1240 to change setting (S1627).

In FIG. 16, the optical transceiver-11 of the aggregator secton-1 having transitioned from the running state to the minimum power mode is made to transition to the set-up mode (S1614). Then, an optical transceiver-21 in the set-up mode of the aggregator section-2 is made to transition to the minimum power mode (S1618→S1619). Due to this reallocation of the operation modes of the optical transceivers, since all optical transceivers connecting to the aggregator section-2 are in the minimum power mode, the aggregator section-2 is made to transition from the high-speed startup mode to the minimum power mode (S1643→S1645).

Finally, the power consumption control section 1220 registers the changed states in the usage state table (S1629), and the node control section 230 notifies the number of high-speed startup modes after change to the entire network (S1635, S1677).

In this manner, power-saving modes are also applied to the aggregator sections 1240 in conjunction with the optical transceivers 210, whereby an even more reduction in power consumption can be achieved while high-speed startup is realized.

### 5.4) Specific Example of Operation of Optical Communication Network System

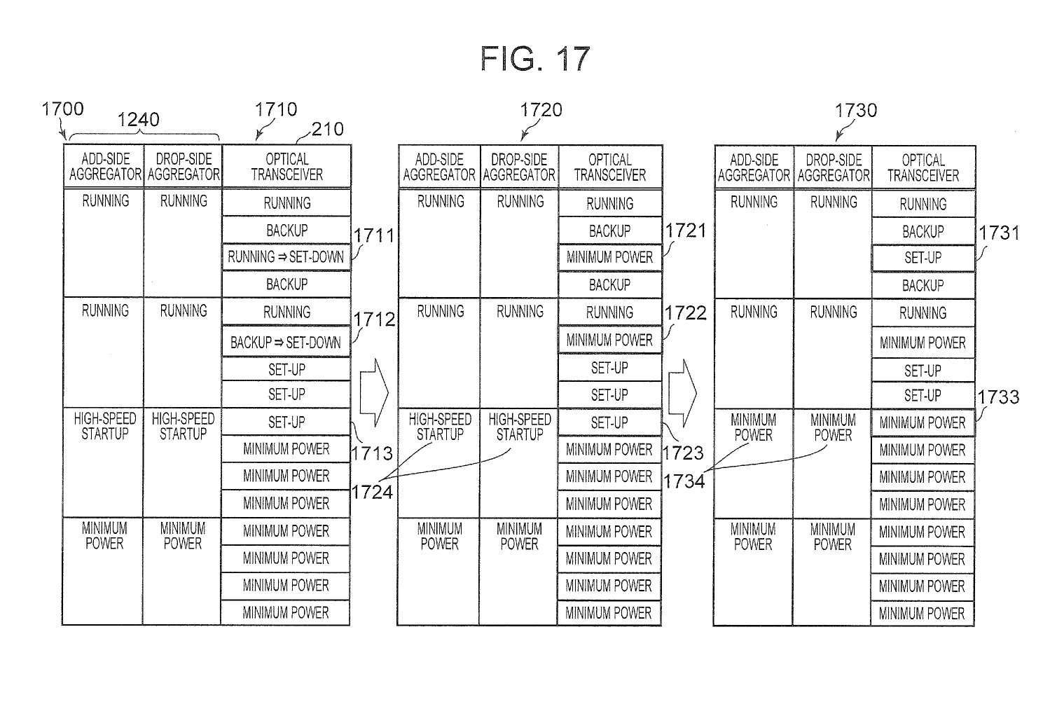

FIG. 17 shows an example 1700 of combinations of the power-saving standby modes according to the fifth exemplary embodiment. Here, a more detailed description will be given of the optical path set-down and reallocation described following FIG. 16.

Referring to FIG. 17, four optical transceivers 210 are connected to an aggregator section 1240, and combinations of the power-saving standby modes at four aggregator sections are shown. As an example, shown is a case where, as a combination of the aggregator sections, the first and second aggregator sections are running, the third one is standing by in the high-speed startup mode, and the fourth one's operation mode is the minimum power mode. In addition, shown is a state where an optical transceiver of the third aggregator section is standing by in the set-up mode (see 1713 in FIG. 17).

When an optical path is set down, one running optical transceiver and one optical transceiver in the backup mode change to the minimum power mode (see 1711→1721, 1712→1722 in FIG. 17). For example, it is assumed that an obtained result is that in this new state, three optical transceivers in the set-up mode are maintained. As shown in the middle diagram of FIG. 17, for the three optical transceivers in the set-up mode, an optical transceiver in the set-up mode connecting to the third aggregator section standing by in the high-speed startup mode (see 1723 in FIG. 17) is confirmed. Moreover, two optical transceivers in the set-up mode connecting to the running second aggregator section are confirmed. Furthermore, two optical transceivers in the minimum power mode connecting to the two running aggregator sections (1721 and 1722 in FIG. 17) are confirmed.

Then, one optical transceiver connecting to the running first aggregator section is changed from the minimum power mode to the set-up mode (see 1721→1731 in FIG. 17). At the same time, one optical transceiver in the set-up mode connecting to the third aggregator section standing by in the high-speed startup mode is changed to the minimum power mode (see 1723→1733 in FIG. 17). Due to this reallocation of the operation modes of the optical transceivers, all of the optical transceivers connecting to the third aggregator section standing by in the high-speed startup mode have come in the minimum power mode. Lastly, the third aggregator section standing by in the high-speed startup mode is changed to the minimum power mode (see 1724→1734 in FIG. 17).

Through such operations for setting up/down a path, there are always the minimum number of aggregator sections and optical transceivers in the standby modes capable of high-speed startup (the set-up mode for the optical transceivers, and the high-speed startup mode for the aggregator sections). Accordingly, a node device can be realized that has an effect of reducing the maximum amount of power consumption and can start up at high speed. In addition, the backup mode for a backup path is newly provided, whereby the period taken to recover from a failure can be further shortened.

Note that the procedure of setting the optical transceivers and the aggregator sections in the node device at the time of setting up/down an optical path according to the present exemplary embodiment is thoroughly an example and is not restrictive. Moreover, the present exemplary embodiment is also applicable to a node for a conventional packet communication network. However, since packet intervals are short, the power-saving effect is smaller than that obtained when it is applied to an optical path network.

According to the present exemplary embodiment, since closed control is performed within a node device, the increased parameter at the network control device 270 is only the number of optical transceivers capable of high-speed startup, or the number of optical transceivers in the set-up mode in the fifth exemplary embodiment. Therefore, a reduction in power consumption of a node can be achieved without imposing a heavy load on the network control device 270. If an attempt is made to have the network control device 270 execute this entire power-saving functionality through centralized management, time for exchanges between node devices and for data collection is required, resulting not only in it becoming difficult to accomplish high-speed startup but also in a network load increasing.

### 5.5) Hardware Configuration of Node Device

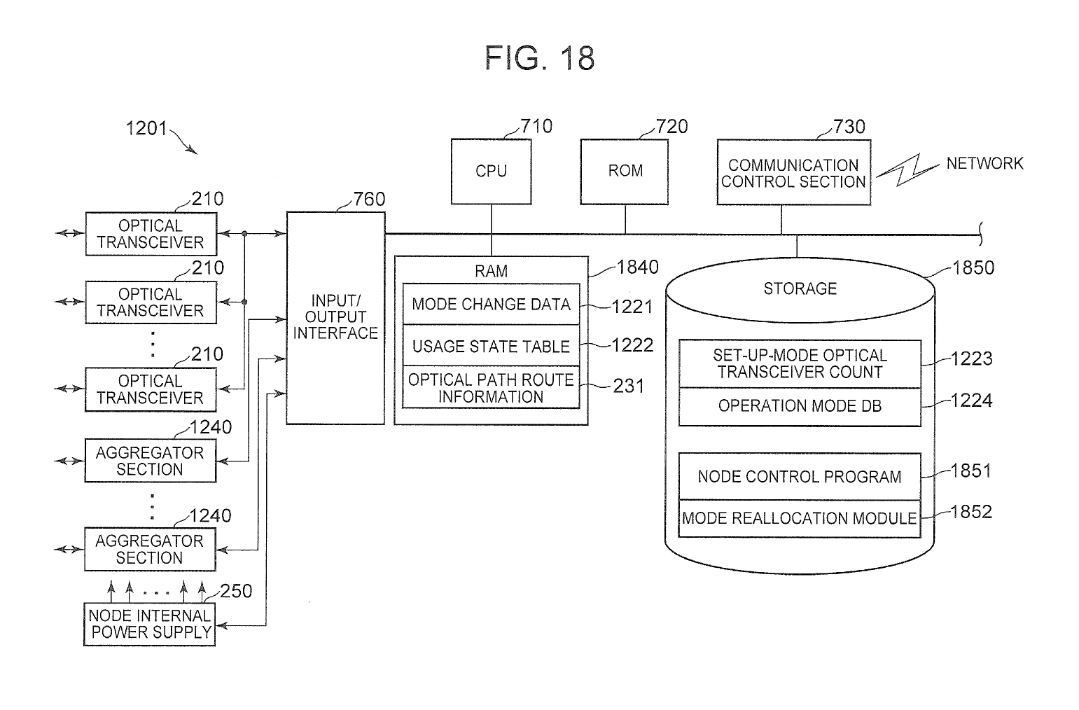

FIG. 18 shows a hardware configuration of the node device 1201 according to the fifth exemplary embodiment. Note that components in FIG. 18 that are similar to those of the second exemplary embodiment in FIG. 7 and those of the fifth exemplary embodiment in FIG. 12 are given the same reference signs as in FIGS. 7 and 12, and details thereof will be omitted here.

A RAM 1849 is a random access memory used as a work area for temporary memory by the CPU 710. In the RAM 1840, areas for storing data necessary to implement the present exemplary embodiment are secured. In the respective areas, the mode change data 1221 and the usage state table 1222 shown in FIG. 12, in addition to the optical path route information 231, are stored.

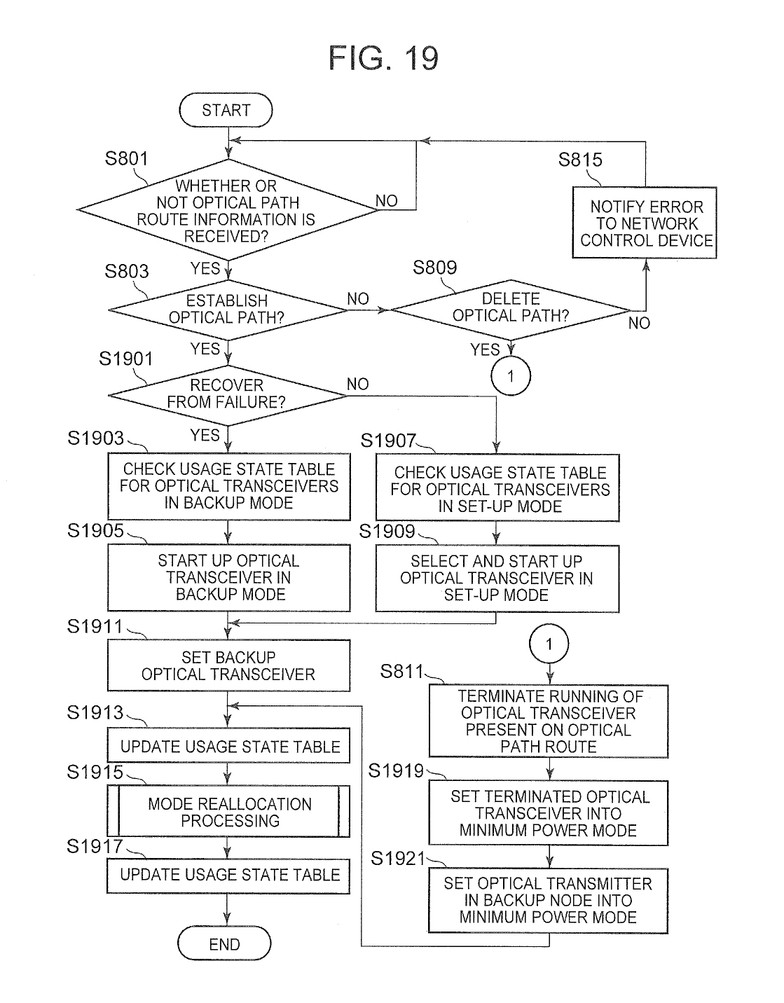

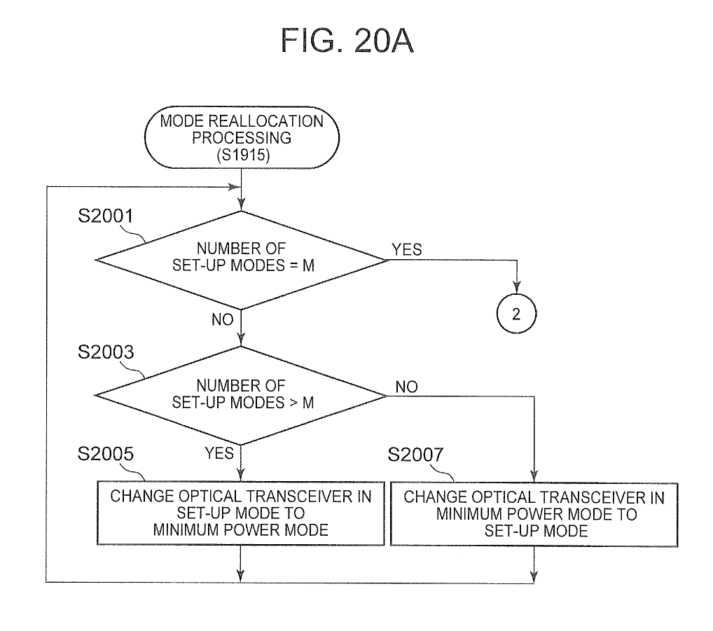

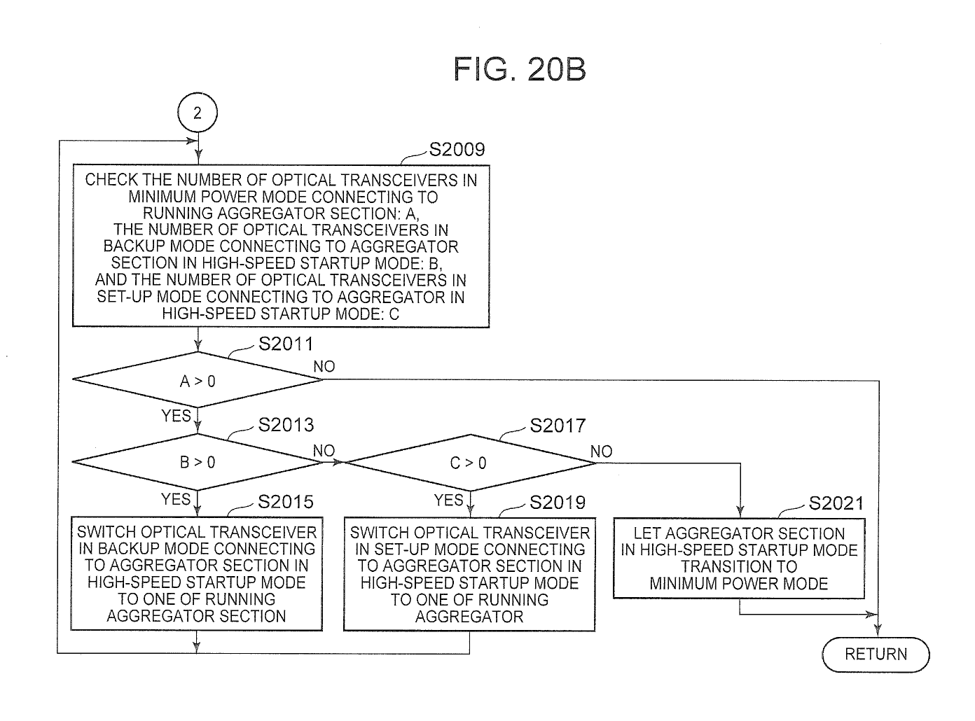

A storage 1850 is a large-capacity storage device that stores databases, various parameters, and programs to be executed by the CPU 710 in a nonvolatile manner. In the storage 1850, following data or programs necessary to implement the present exemplary embodiment are stored. For data, the high-speed-startup-mode optical transceiver count 1223 and the operation mode DB 1224 shown in FIG. 12 are stored. Additionally, in the present exemplary embodiment, for programs, a node control program 1851 indicating a procedure of optical path control of the entire node device (see FIG. 19) and a mode reallocation module 1852 for reallocation of the operation modes of the optical transceivers (see FIGS. 20A and 20B) are stored.

An input/output interface 760 is an interface for receiving as inputs data necessary for control by the CPU 710 and outputting control signals. Interfaces with the optical transceivers 210, the aggregator sections 1240, and the node internal power supply 250 are made by the input/output interface 760.

Note that FIG. 18 only shows the data and programs essential to the present exemplary embodiment and does not show general data or programs such as OS.

### 5.6) Optical Path Control Procedure of Node Device

FIG. 19 shows an optical path control procedure of the node device 1201 according to the fifth exemplary embodiment. In the flowchart of FIG. 19, steps similar to those of the flowchart of FIG. 8 are given the same reference signs, and details thereof will be omitted here. The CPU 710 of the node device 1201 shown in FIG. 18 executes a control flow shown in FIG. 19 by using the RAM 740, whereby the functions of the control sections in FIG. 12 are implemented.

In determination at Step S803, if optical path route information is for optical path set-up (establishment), the process goes to Step S1901, where it is determined whether or not the optical path establishment is for recovery from a failure. If it is for recovery from a failure, then in Step S1903, optical transceivers in the backup mode are checked for from the usage state table 1222, and in Step S1905, an optical transceiver in the backup mode is started up. In selection of this optical transceiver in the backup mode, the first priority is placed on one connecting to an aggregator section in the running state, and the second priority is placed on one connecting to an aggregator section running in the high-speed startup mode.

If the optical path establishment is not for recovery from a failure, then in Step S1907, optical transceivers in the set-up mode are checked for from the usage state table 1222, and in Step S1909, an optical transceiver in the set-up mode is started up. In selection of this optical transceiver in the set-up mode as well, the first priority is placed on one connecting to an aggregator section in the running state, and the second priority is placed on one connecting to an aggregator section running in the high-speed startup mode.

In Step S1911, because the optical transceiver in the backup mode or the optical transceiver in the set-up mode has been started up, a corresponding optical transceiver for backup is set and made to transition to the backup mode. In selection of this optical transceiver made to transition to the backup mode as well, the first priority is placed on one connecting to an aggregator section in the running state, and the second priority is placed on one connecting to an aggregator section running in the high-speed startup mode.

On the other hand, in determination at Step S809, if optical path route information is for optical path set-down (deletion), the process goes to Step S811, where running of an optical transceiver present in an optical path route designated by the optical path route information is terminated. Then in Step S1919, the optical transceiver whose running has been terminated is made to transition to the minimum power mode, and in Step S1921, a corresponding optical transceiver in the backup mode is also made to transition to the minimum power mode.

In Step S1913, the usage state table 1222 is updated so as to respond to the changes in usage state of the optical transceivers and the aggregator sections made by the optical path set-up (establishment) or optical path set-down (deletion). In Step S1915, mode reallocation processing is performed based on the changed usage state table 1222 and the set-up-mode optical transceiver count 1223. This mode reallocation processing is shown in detail in FIGS. 20A and 20B. In Step 51917, the usage state table 1222 is updated so as to respond to a change in usage state of the optical transceivers and the aggregator sections updated by the mode reallocation processing.

### 5.7) Mode Reallocation Processing Procedure

FIGS. 20A and 20B are flowcharts showing a procedure of the mode reallocation processing (S1915 in FIG. 19) of the node device 1201 according to the fifth exemplary embodiment.

First, in Step S2001, it is determined whether or not the current number of optical transceivers in the set-up mode is M that is designated by the set-up-mode optical transceiver count data 1223. If the number is M, the process goes to Step S2009 in FIG. 20B.

If the number of optical transceivers in the set-up mode is not M, then in Step S2003, it is determined whether the number of optical transceivers in the set-up mode is larger or smaller than M. When the number is larger than M, the process goes to Step S2005, where an optical transceiver in the set-up mode is changed to the minimum power mode so that the number of optical transceivers in the set-up mode will be M. On the other hand, if the number is smaller than M, the process goes to Step S2007, where an optical transceiver in the minimum power mode is changed to the set-up mode so that the number of optical transceivers in the set-up mode will be M. Note that in the fifth exemplary embodiment as well, reallocation is performed with further consideration given such that an optical transceiver in the set-up mode will exist in each direction, but an illustration is simplified in FIG. 20A to avoid complication. However, a procedure thereof should be obvious to those ordinarily skilled in the art.

If the number of optical transceivers in the set-up mode is the designated M, then in Step S2009, following parameters A, B, and C are checked. The parameter A is the number of optical transceivers in the minimum power mode connecting to running aggregator sections. The parameter B is the number of optical transceivers in the backup mode connecting to aggregator sections in the high-speed startup mode. Moreover, the parameter C is the number of optical transceivers in the set-up mode connecting to aggregator sections in the high-speed startup mode.

In Step S2011, it is determined whether or not A>0, and when A=0, the mode reallocation processing is ended. If A>0, then in Step S2013, it is determined whether or not B>0. If B>0, the process goes to Step S2015, where an optical transceiver in the backup mode connecting to an aggregator section in the high-speed startup mode is switched to one of a running aggregator section. This processing is processing to eliminate a state where an optical transceiver in the backup mode is connecting to an aggregator section standing by in the high-speed startup mode while an optical transceiver in the minimum power mode is connecting to a running aggregator section. When a determination in Step S2011 comes out as A=0 while this processing is repeated, the mode reallocation processing is ended.

However, if A>0 even after B optical transceivers in the backup mode connecting to the aggregator sections in the high-speed startup mode are switched to ones of the running aggregator sections, the process proceeds in the order of “Steps S2011→S2013→S2017,” and then it is determined whether or not C>0. If C>0, the process goes to Step S2019, where an optical transceiver in the set-up mode connecting to an aggregator section in the high-speed startup mode is switched to one of a running aggregator section. This processing is processing to eliminate a state where an optical transceiver in the set-up mode is connecting to an aggregator section standing by in the high-speed startup mode while an optical transceiver in the minimum power mode is connecting to a running aggregator section. When a determination in Step S2011 comes out as A=0 while this processing is repeated, the mode reallocation processing is ended.

When C=0, the process goes to Step S2021, where, since the aggregator sections in the high-speed startup mode only have optical transceivers in the minimum power mode, the aggregator sections in the high-speed startup mode are changed to the minimum power mode, and the mode reallocation processing is ended. As described above, through the processing of Steps S2009 through S2021, switch is made such that optical transceivers in the backup mode or in the set-up mode will connect to the running aggregator sections. Thus, the aggregator sections that have no optical transceivers in the backup mode or in the set-up mode (only have optical transceivers in the minimum power mode) are changed from the high-speed startup mode to the minimum power mode, whereby the amount of power consumption can be reduced from 35 W to 4 W.

### 6. Sixth Exemplary Embodiment

In the second to fifth exemplary embodiments, the number of optical transceivers for high-speed startup that should be maintained by each node device is set by each node device. In a sixth exemplary embodiment, a network control device collects the states of individual node devices. An example will be shown in which the number of optical transceivers in the high-speed function mode to be maintained in case of the node devices of the second exemplary embodiment, or the number of optical transceivers in the set-up mode in case of the node devices of the fifth exemplary embodiment, is dynamically set on each node device. According to the present exemplary embodiment, a reduction in the amount of power consumption of an entire optical path network can be realized on a larger scale, not as a sum of reduced amounts of power consumption individually achieved by individual node devices, but including control of optical path routes and allocation of optical paths to the node devices in the entire optical path network.

### 6.1) System Configuration

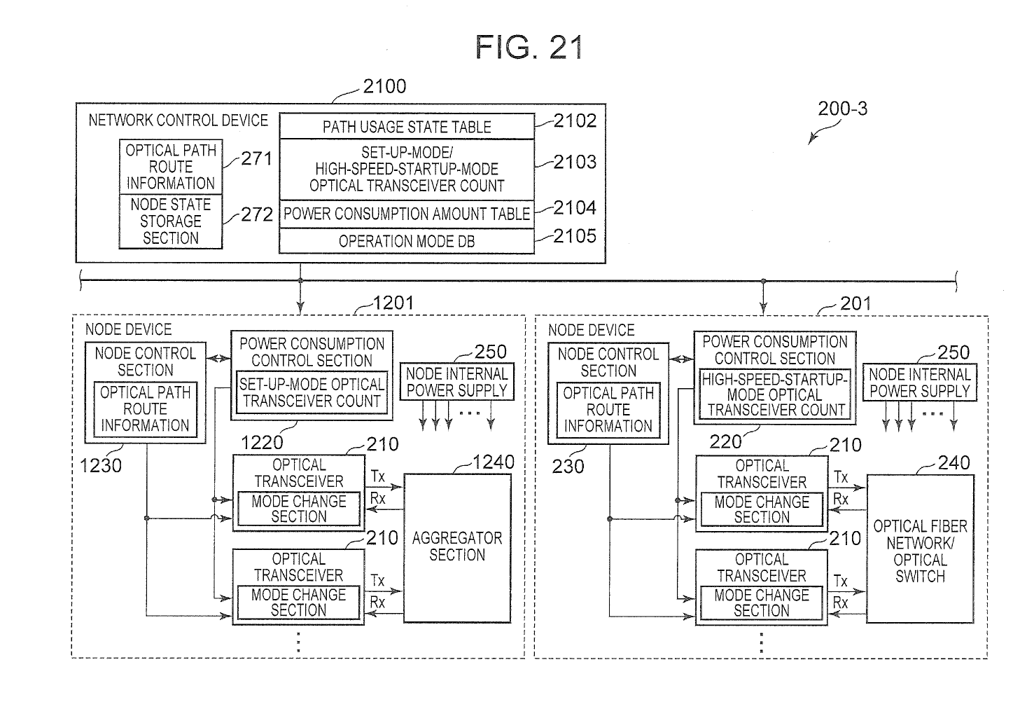

FIG. 21 is a block diagram showing configurations of an optical path network system 200-3 that is an optical communication network system according to the sixth exemplary embodiment, a network control device 2100, and node devices 201 and 1201. The configurations of the node devices 201 and 1201 in the sixth exemplary embodiment are illustrated in a simplified manner in FIG. 21 but basically are similar to those of the second to fifth exemplary embodiments. The sixth exemplary embodiment is different from the second to fifth exemplary embodiments in the point that the number of optical transceivers for high-speed startup that should be maintained by each node device is determined not by each node device but by the network control device. Hereinafter, a description will be given of part different from the second to fifth exemplary embodiments, and a description of similar functional component sections will be omitted.

The network control device 2100 in FIG. 21 has data as described below for calculation of the number of optical transceivers for high-speed startup that should be maintained by each node device to set on each node device, in addition to optical path route information 271 and a node state storage section 272 used to establish/delete an optical path. This data includes a path usage state table 2102 that stores how paths linking node devises are used. Moreover, the data includes set-up-mode/high-speed-startup-mode optical transceiver count data 2103 and a power consumption amount table 2104 that store, for all node devices in a discriminable manner, those stored only by node devices in the second to fifth exemplary embodiments. Further, the data includes an operation mode DB 2105 that stores operation modes associated with the individual node devices.

### 6.2) Hardware Configuration of Network Control Device

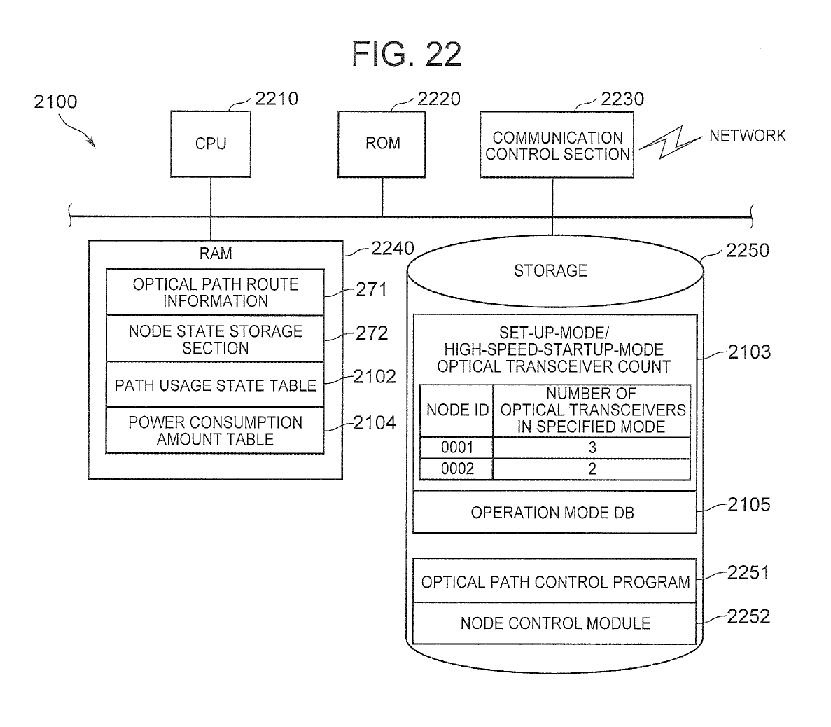

FIG. 22 is a block diagram showing a hardware configuration of the network control device 2100 according to the sixth exemplary embodiment.

In FIG. 22, a CPU 2210 is a processor for operation control and implements each functional component section in FIG. 21 by executing programs. A ROM 2220 stores fixed data and programs such as initial data and programs. A communication control section 2230 communicates with external devices through a network. Communication with each of the node devices 201 and 1201 is performed through the communication control section 2230. Communication may be wireless or may be wired.

A RAM 2240 is a random access memory to be used as a work area for temporary memory by the CPU 2210. In the RAM 2240, areas for storing data necessary to implement the present exemplary embodiment are secured. In the respective areas, the path usage state table 2102 and the power consumption amount table 2104 shown in FIG. 21, in addition to the optical path route information 271 and the node state storage section 272, are stored.

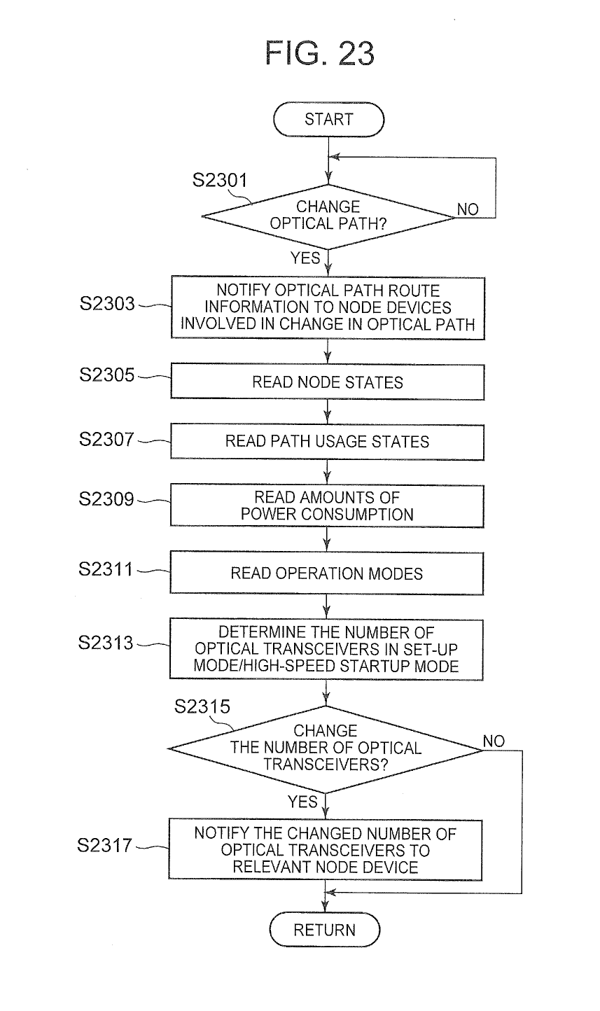

A storage 2250 is a large-capacity storage device that stores database, various parameters, and programs to be executed by the CPU 2210 in a nonvolatile manner. In the storage 2250, following data or programs necessary to implement the present exemplary embodiment are stored. For data, the set-up-mode/high-speed-startup-mode optical transceiver count data 2103 and the operation mode DB 2105 shown in FIG. 21 are stored. Moreover, in the present exemplary embodiment, for programs, an optical path control program 2251 indicating an optical path control procedure of the entire optical path network system 200-3 is stored. Furthermore, a node control module 2252 for control of the node devices based on the number of optical transceivers for high-speed startup that should be maintained by each node device is stored (see FIG. 23).

Note that FIG. 22 only shows the data and programs essential to the present exemplary embodiment and does not show general data or programs such OS.

### 6.3) Optical Path Control Procedure of Network Control Device

FIG. 23 is a flowchart showing an optical path control procedure of the network control device according to the sixth exemplary embodiment. Note that this flowchart is executed by the CPU 2210 of the network control device 2100 in FIG. 22 using the RAM 2240, whereby the functions of the network control device in FIG. 21 are implemented.

First, in Step S2301, it is determined whether or not a change (set-up/set-down, a failure or recover from a failure) occurs in optical paths. If there is a change in optical paths, the process goes to Step S2303, where optical path route information is notified to node devices involved in the change in optical paths.

Subsequently, in Steps S2305 to S2311, data for determining the set-up-mode/high-speed-startup-mode optical transceiver count data 2103 on each node device is read out. In Step S2305, the current states of the node devices such as operation enabled/disabled are read out from the node state storage section 272. In Step S2307, paths currently used, the amount of traffic of each node device based on the route, and the like are read out from the path usage state table 2102. In Step S2309, the amount of power consumption of each node device is read out from the power consumption amount table 2104. In Step S2311, the operation mode of each node device is read out from the operation mode DB 2105.

In Step S2313, using at least one of the read out data described above, the set-up-mode/high-speed-startup-mode optical transceiver count data 2103 on each node device is determined. In Step S2315, for each node device, it is determined whether or not a change in the number of optical transceivers in the set-up mode/high-speed startup mode is needed. If no change is needed, the process is ended. If a change is needed, then in Step S2317, a changed number of optical transceivers is notified to a relevant node device.

As described above, the amount of power consumption and the startup period of each node device are dynamically controlled, responding to the current state of affairs including the amount of traffic and the like of the optical path network system 200-3. Thereby, a reduction in the amount of power consumption and an increase in performance such as the startup period in the entire optical path network system 200-3 can be achieved.

### 7. Other Embodiments

Hereinabove, although exemplary embodiments of the present invention have been described in detail, systems or devices configured by combining in any way different characteristics included in the respective exemplary embodiments are also incorporated in the scope of the present invention.

Moreover, the present invention may be applied to a system comprised of a plurality of devices or may be applied to a single-unit device. Further, the present invention is also applicable in a case where control programs implementing the functions of the exemplary embodiments are directly or remotely provided to a system or a device. Therefore, control programs to be installed in a computer, or media storing such control programs and WWW (World Wide Web) servers downloading such control programs, are also incorporated in the scope of the present invention.

Following effects can be obtained by combining the above-described exemplary embodiments of the present invention.

High-speed startup is possible while a reduction in power consumption of optical transceivers during standby is achieved.
Standby modes are determined such that the startup period from a standby mode and power consumption will be in inverse proportion, whereby the number of standby modes can be minimized.
Among a plurality of optical transceivers standing by, a necessary number of optical transceivers for recovery from a failure are kept in a state capable of high-speed startup, based on the usage states of the optical transceivers, and the others are kept in a state of minimum power use. Thus, the power consumption of optical transceivers can be made smaller.
A control section is disposed in a network node, whereby control parameters to a control section managing an entire network can be minimized.
A state capable of high-speed startup can be realized while a reduction in power consumption during standby of devices operating with optical transceivers is also achieved.
Standby modes of optical transceivers and devices operating with the optical transceivers can be controlled, and power consumption during standby can be further reduced by differently using the standby modes in accordance with the state of a network.
A configuration can be made such that a group of devices operating with optical transceivers is in a standby mode with the lowest power consumption.
In application to an optical path network, an optical transceiver in a long-time unused state, which is one of the characteristics of optical path networks, can be made in a state of reduced power consumption, and high-speed recovery from a failure can also be realized.
Application is possible to applications requiring the high reliability of 50 msec.
In application to an entire network, a reduction in power consumption can be achieved not only in nodes but also in the entire network.

### 8. Additional Statements

Part or all of the above-described exemplary embodiments also can be stated as in, but is not limited to, the following additional statements.

### (Additional Statement 1)

A node device in an optical communication network system, characterized by comprising:

a plurality of optical transceiver means on which a plurality of standby modes can be selectively set, wherein the standby modes include a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby; and

a power consumption control means which, based on usage states of the plurality of optical transceiver means and a predetermined number of optical transceivers that should stand by in the first standby mode, dynamically allocates the plurality of standby modes to the plurality of optical transceiver means so that a total amount of power consumption of the node device will be smaller.

### (Additional Statement 2)

The node device according to additional statement 1, characterized in that the predetermined number of optical transceiver means that should stand by in the first standby mode is set based on any of a number of directions connected to the node device, a total number of paths set in the directions, and a change in the total number of paths set in the directions.

(Additional statement 3)

The node device according to additional statement 1 or 2, characterized in that when newly starting up an optical transceiver means, the power consumption control means selects and starts up an optical transceiver means standing by in the first standby mode among the plurality of optical transceiver means.

(Additional statement 4)

The node device according to any one of additional statements 1 to 3, characterized in that when a number of optical transceivers standing by in the first standby mode is not the predetermined number, the power consumption control means changes a standby mode of an optical transceiver means standing by in the first standby mode or in the second standby mode so that the number of optical transceivers standing by in the first standby mode will be the predetermined number.

### (Additional Statement 5)

The node device according to any one of additional statements 1 to 4, characterized in that the first standby mode is a backup mode for allowing a first optical transmitter means to stand by as a backup for another running optical transceiver means.

### (Additional Statement 6)

The node device according to additional statement 5, characterized in that the plurality of standby modes include a third standby mode in which the startup period is longer than that of the backup mode and shorter than the allowable interruption period, and for power consumption during standby, a third amount of power that is smaller than the first amount of power and larger than the second amount of power is consumed.

### (Additional Statement 7)

The node device according to additional statement 5 or 6, characterized in that the power consumption control means sets the first optical transceiver means into the backup mode for a backup of the another optical transceiver means when the another optical transceiver means has transitioned to a running state, and sets the first optical transceiver means into the second standby mode when the another optical transceiver means has transitioned from the running state to a standby state.

### (Additional Statement 8)

The node device according to any one of additional statements 1 to 7, characterized in that each of the plurality of optical transceiver means includes a first mode change means which changes standby modes according to an instruction from the power consumption control means.

### (Additional Statement 9)

The node device according to any one of additional statements 1 to 8, characterized by further comprising a plurality of direction selector means which are connected to the plurality of optical transceiver means and collectively and selectively transmit/receive a plurality of optical signals to/from different directions on a network side,

wherein each of the plurality of direction selector means can be set in a plurality of direction selection standby modes including a fourth standby mode in which the startup period is shorter than the allowable interruption period in the optical communication system and a fourth amount of power is consumed during standby, and a fifth standby mode in which the startup period is longer than the allowable interruption period and a fifth amount of power that is smaller than the fourth amount of power is consumed during standby, and

the power consumption control means dynamically allocates the plurality of direction selection standby modes to the plurality of direction selector means so that a number of direction selectors in the fifth standby mode will be increased while the number of optical transceiver means in the first standby mode is maintained.

### (Additional Statement 10)

The node device according to additional statement 9, characterized in that when there is a first optical transceiver means standing by in the second standby mode among a plurality of optical transceiver means connecting to a running direction selector means, the power consumption control section changes a second optical transceiver means standing by in the first standby mode and connecting to another direction selector means standing by in the fourth standby mode into the second standby mode, and also changes the first optical transceiver means into the first standby mode.

### (Additional Statement 11)

The node device according to additional statement 9 or 10, characterized in that each of the plurality of direction selector means includes a second mode change means that changes standby modes according to an instruction from the power consumption control means.

### (Additional Statement 12)

The node device according to any one of additional statements 1 to 11, characterized in that the allowable interruption period is 50 milliseconds.

### (Additional Statement 13)

The node device according to any one of additional statements 1 to 12,

wherein the optical communication network system is an optical path network system, characterized in that

the power consumption control means dynamically allocates the plurality of standby modes to the plurality of optical transceiver means with consideration also given to optical path route information set on the node device.

### (Additional Statement 14)

A power saving control method for a node device in an optical communication network system, the node device including a plurality of optical transceiver means on which a plurality of standby modes can be selectively set, the method characterized by comprising:

making available a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby; and

based on usage states of the plurality of optical transceiver means and a predetermined number of optical transceiver means that should stand by in the first standby mode, dynamically allocating the plurality of standby modes to the plurality of optical transceiver means so that a total amount of power consumption of the node device will be smaller.

### (Additional Statement 15)

The power saving control method according to additional statement 14, characterized in that the predetermined number of optical transceiver means that should stand by in the first standby mode is set based on any of a number of directions connected to the node device, a total number of paths set in the directions, and a change in the total number of paths set in the directions.

### (Additional Statement 16)

The power saving control method according to additional statement 14 or 15, characterized in that when newly starting up an optical transceiver means, an optical transceiver means standing by in the first standby mode among the plurality of optical transceiver means is selected and started up.

### (Additional Statement 17)

The power saving control method according to any one of additional statements 14 to 16, characterized in that when a number of optical transceivers standing by in the first standby mode is not the predetermined number, a standby mode of an optical transceiver means standing by in the first standby mode or in the second standby mode is changed so that the number of optical transceivers standing by in the first standby mode will be the predetermined number.

### (Additional Statement 18)

The power saving control method according to any one of additional statements 14 to 17, characterized in that the first standby mode is a backup mode for allowing a first optical transmitter means to stand by as a backup for another running optical transceiver means.

### (Additional Statement 19)

The power saving control method according to additional statement 18, characterized in that the plurality of standby modes include a third standby mode in which the startup period is longer than that of the backup mode and shorter than the allowable interruption period, and for power consumption during standby, a third amount of power that is smaller than the first amount of power and larger than the second amount of power is consumed.

### (Additional Statement 20)

The power saving control method according to additional statement 18 or 19, characterized in that the first optical transceiver means is set into the backup mode for a backup of the another optical transceiver means when the another optical transceiver means has transitioned to a running state, and the first optical transceiver means is set into the second standby mode when the another optical transceiver means has transitioned from the running state to a standby state.

### (Additional Statement 21)

The power saving control method according to any one of additional statements 14 to 20, characterized in that

the node device further comprises a plurality of direction selector means which are connected to the plurality of optical transceiver means and collectively and selectively transmit/receive a plurality of optical signals to/from different directions on a network side,

wherein each of the plurality of direction selector means can be set in a plurality of direction selection standby modes including a fourth standby mode in which the startup period is shorter than the allowable interruption period in the optical communication system and a fourth amount of power is consumed during standby, and a fifth standby mode in which the startup period is longer than the allowable interruption period and a fifth amount of power that is smaller than the fourth amount of power is consumed during standby, and

the plurality of direction selection standby modes are dynamically allocated to the plurality of direction selector means so that a number of direction selectors in the fifth standby mode will be increased while the number of optical transceiver means in the first standby mode is maintained.

### (Additional Statement 22)

The power saving control method according to additional statement 21, characterized in that when there is a first optical transceiver means standing by in the second standby mode among a plurality of optical transceiver means connecting to a running direction selector means, a second optical transceiver means standing by in the first standby mode and connecting to another direction selector means standing by in the fourth standby mode is changed into the second standby mode, and the first optical transceiver means is changed into the first standby mode.

### (Additional Statement 23)

The power saving control method according to any one of additional statements 14 to 22, characterized in that the allowable interruption period is 50 milliseconds.

### (Additional Statement 24)

The power saving control method according to any one of additional statements 14 to 23,

wherein the optical communication network system is an optical path network system, characterized in that

the plurality of standby modes are dynamically allocated to the plurality of optical transceiver means with consideration also given to optical path route information set on the node device.

### (Additional Statement 25)

An optical communication network system in which a plurality of node devices are connected through a plurality of optical fiber lines,

wherein each of the plurality of node devices includes a plurality of optical transceiver means on which a plurality of standby modes can be selectively set, the standby modes including a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby, the system characterized by comprising:

a network control means which sets a predetermined number of optical transceiver means that should stand by in the first standby mode for each of the plurality of node devices and controls communication performed by the plurality of node devices; and

a power consumption control means which, based on usage states of the plurality of optical transceiver means and the predetermined number of optical transceiver means that should stand by in the first standby mode, dynamically allocates the plurality of standby modes to the plurality of optical transceiver means so that a total amount of power consumption of a relevant node device will be smaller.

### (Additional Statement 26)

A power saving method in an optical communication network system in which a plurality of node devices are connected through a plurality of optical fiber lines,

wherein each of the plurality of node devices includes a plurality of optical transceiver means on which a plurality of standby modes can be selectively set, the standby modes including a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby, the method characterized by comprising:

a network control step for setting a predetermined number of optical transceiver means that should stand by in the first standby mode for each of the plurality of node devices and controlling communication performed by the plurality of node devices; and

a power consumption control step for, based on usage states of the plurality of optical transceiver means and the predetermined number of optical transceiver means that should stand by in the first standby mode, dynamically allocating the plurality of standby modes to the plurality of optical transceiver means so that a total amount of power consumption of a relevant node device will be smaller.

### INDUSTRIAL APPLICABILITY

The present invention can be used as a power saving technology for node devices or a network control device in an optical communication system.

### REFERENCE SIGNS LIST

100 Optical communication system
110 Node device
111 Optical transceiver
112 Power consumption control section
120 Optical fiber network

1. A node device in an optical communication network system, comprising:
a plurality of optical transceivers on which a plurality of standby modes can be selectively set, wherein the standby modes include a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby; and
a power consumption controller which, based on usage states of the plurality of optical transceivers and a predetermined number of optical transceivers that should stand by in the first standby mode, dynamically allocates the plurality of standby modes to the plurality of optical transceiver means so that a total amount of power consumption of the node device will be smaller.

2. The node device according to claim 1, wherein the predetermined number of optical transceivers that should stand by in the first standby mode is set based on any of a number of directions connected to the node device, a total number of paths set in the directions, and a change in the total number of paths set in the directions.

3. The node device according to claim 1, wherein when newly starting up an optical transceiver, the power consumption controller selects and starts up an optical transceiver standing by in the first standby mode among the plurality of optical transceivers.

4. The node device according to claim 1, wherein when a number of optical transceivers standing by in the first standby mode is not the predetermined number, the power consumption controller changes a standby mode of an optical transceiver standing by in the first standby mode or in the second standby mode so that the number of optical transceivers standing by in the first standby mode will be the predetermined number.

5. The node device according to claim 1, wherein the first standby mode comprises a backup mode for allowing an optical transceiver to stand by as a backup for another running optical transceiver.

6. The node device according to claim 5, wherein the plurality of standby modes include a third standby mode in which the startup period is longer than that of the backup mode and shorter than the allowable interruption period, and for power consumption during standby, a third amount of power that is smaller than the first amount of power and larger than the second amount of power is consumed.

7. The node device according to claim 1, further comprising a plurality of direction selectors which are connected to the plurality of optical transceivers and collectively and selectively transmit/receive a plurality of optical signals to/from different directions on a network side,
wherein each of the plurality of direction selectors can be set in a plurality of direction selection standby modes including a fourth standby mode in which the startup period is shorter than the allowable interruption period in the optical communication system and a fourth amount of power is consumed during standby, and a fifth standby mode in which the startup period is longer than the allowable interruption period and a fifth amount of power that is smaller than the fourth amount of power is consumed during standby, and
the power consumption controller dynamically allocates the plurality of direction selection standby modes to the plurality of direction selectors so that a number of direction selectors in the fifth standby mode will be increased while the number of optical transceiver in the first standby mode is maintained.

8. A power saving control method for a node device in an optical communication network system, the node device including a plurality of optical transceivers on which a plurality of standby modes can be selectively set, the method comprising:
making available a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby; and
based on usage states of the plurality of optical transceivers and a predetermined number of optical transceivers that should stand by in the first standby mode, dynamically allocating the plurality of standby modes to the plurality of optical transceivers so that a total amount of power consumption of the node device will be smaller.

9. An optical communication network system in which a plurality of node devices are connected through a plurality of optical fiber lines,
wherein each of the node devices includes a plurality of optical transceivers on which a plurality of standby modes can be selectively set, the standby modes including a first standby mode in which a startup period is shorter than an allowable interruption period in the optical communication system and a first amount of power is consumed during standby, and a second standby mode in which the startup period is longer than the allowable interruption period and a second amount of power that is smaller than the first amount of power is consumed during standby,
the system comprising:
a network controller which sets a predetermined number of optical transceivers that should stand by in the first standby mode for each of the node devices and controls communication performed by the node devices; and
a power consumption controller which, based on usage states of the plurality of optical transceivers and the predetermined number of optical transceivers that should stand by in the first standby mode, dynamically allocates the plurality of standby modes to the plurality of optical transceivers so that a total amount of power consumption of a relevant node device will be smaller.

10. (canceled)

11. The power saving control method according to claim 8, wherein the predetermined number of optical transceivers that should stand by in the first standby mode is set based on any of a number of directions connected to the node device, a total number of paths set in the directions, and a change in the total number of paths set in the directions.

12. The power saving control method according to claim 8, wherein when newly starting up an optical transceiver, an optical transceiver standing by in the first standby mode among the plurality of optical transceivers is selected and started up.

13. The power saving control method according to claim 8, wherein when a number of optical transceivers standing by in the first standby mode is not the predetermined number, a standby mode of an optical transceiver standing by in the first standby mode or in the second standby mode is changed so that the number of optical transceivers standing by in the first standby mode will be the predetermined number.

14. The power saving control method according to claim 8, wherein the first standby mode comprises a backup mode for allowing a first optical transceiver to stand by as a backup for another running optical transceiver.

15. The power saving control method according to claim 14, wherein the plurality of standby modes include a third standby mode in which the startup period is longer than that of the backup mode and shorter than the allowable interruption period, and for power consumption during standby, a third amount of power that is smaller than the first amount of power and larger than the second amount of power is consumed.

16. The power saving control method according to claim 8, wherein
the node device further comprises a plurality of direction selectors which are connected to the plurality of optical transceivers and collectively and selectively transmit/receive a plurality of optical signals to/from different directions on a network side,
wherein each of the plurality of direction selectors can be set in a plurality of direction selection standby modes including a fourth standby mode in which the startup period is shorter than the allowable interruption period in the optical communication system and a fourth amount of power is consumed during standby, and a fifth standby mode in which the startup period is longer than the allowable interruption period and a fifth amount of power that is smaller than the fourth amount of power is consumed during standby, and
the plurality of direction selection standby modes are dynamically allocated to the plurality of direction selectors so that a number of direction selectors in the fifth standby mode will be increased while the number of optical transceiver in the first standby mode is maintained.

17. The optical communication network system according to claim 9, wherein the predetermined number of optical transceivers that should stand by in the first standby mode is set based on any of a number of directions connected to the node device, a total number of paths set in the directions, and a change in the total number of paths set in the directions.

18. The optical communication network system according to claim 9, wherein when newly starting up an optical transceiver, the power consumption controller selects and starts up an optical transceiver standing by in the first standby mode among the plurality of optical transceivers.

19. The optical communication network system according to claim 9, wherein when a number of optical transceivers standing by in the first standby mode is not the predetermined number, the power consumption controller changes a standby mode of an optical transceiver standing by in the first standby mode or in the second standby mode so that the number of optical transceivers standing by in the first standby mode will be the predetermined number.

20. The optical communication network system according to claim 9, wherein the first standby mode comprises a backup mode for allowing an optical transceiver to stand by as a backup for another running optical transceiver.

21. The optical communication network system according to claim 19, wherein the plurality of standby modes include a third standby mode in which the startup period is longer than that of the backup mode and shorter than the allowable interruption period, and for power consumption during standby, a third amount of power that is smaller than the first amount of power and larger than the second amount of power is consumed.
